(19) United States
(12) Patent Application Publication
(10) Pub. No.: US 2025/0050671 A1
(43) Pub. Date: Feb. 13, 2025

(54) THERMOSENSITIVE RECORDING LAYER FORMING LIQUID, THERMOSENSITIVE RECORDING MEDIUM AND PRODUCTION METHOD THEREOF, AND IMAGE RECORDING METHOD

(71) Applicants: Hiroaki Matsui, Shizuoka (JP); Shinji Okada, Shizuoka (JP); Shuichiro Abe, Shizuoka (JP); Tohru Kitano, Shizuoka (JP); Yuhei Fujimoto, Shizuoka (JP)

(72) Inventors: Hiroaki Matsui, Shizuoka (JP); Shinji Okada, Shizuoka (JP); Shuichiro Abe, Shizuoka (JP); Tohru Kitano, Shizuoka (JP); Yuhei Fujimoto, Shizuoka (JP)

(73) Assignee: Ricoh Company, Ltd., Tokyo (JP)

(21) Appl. No.: 18/551,515

(22) PCT Filed: Feb. 22, 2022
(86) PCT No.: PCT/JP2022/007427

§ 371 Date: Sep. 20, 2023

(30) Foreign Application Priority Data
Mar. 23, 2021 (JP) 2021-048554
Feb. 16, 2022 (JP) 2022-022083

(51) Int. Cl. B41M 5/333; B41M 5/136

(52) U.S. Cl. CPC B41M 5/3333; B41M 5/136; B41M 2205/04

(57) ABSTRACT

A thermosensitive recording layer forming liquid includes an electron-donating compound, an electron-accepting compound, and a solvent. A solubility of the electron-accepting compound to 100% ethanol at 20° C. is 5.0% by mass or less.

### TECHNICAL FIELD

The present disclosure relates to a thermosensitive recording layer forming liquid, a thermosensitive recording medium and a method for producing a thermosensitive recording medium, and an image recording method

### BACKGROUND ART

In the art, a thermosensitive recording medium, which includes a support formed of paper or synthetic paper, and a thermosensitive recording layer that is disposed on or above the support and utilizes a coloring reaction between an electron-donating compound and an electron-accepting compound, has been widely known.

The thermosensitive recording medium is produced by applying a thermosensitive recording layer forming liquid onto an entire surface of a support by air knife coating, bar coating, blade coating, curtain coating, or gravure coating, and drying the thermosensitive recording layer forming liquid. The thermosensitive recording layer forming liquid is prepared by dispersing an electron-donating compound and an electron-accepting compound, together with a resin (e.g., polyvinyl alcohol) and a dispersant (e.g., a surfactant) into small particles.

Recently, there is a high demand for known thermosensitive recording media to have a partial thermosensitive recording layer formed by a printing system because of at least one of the following reasons.
(1) Design printing and printing using a thermosensitive recording layer forming liquid can be performed at the same time by a typically used printer to reduce cost and environmental loads.
(2) A thermosensitive recording layer is partially disposed only on a desired area to reduce an amount of the thermosensitive recording layer forming liquid for use, and reduce cost and environmental loads.
(3) A thermosensitive recording layer is partially directly disposed only on a desired area so that it is not necessary to use label. Therefore, materials used in the art, such as a base, an adhesive, and a release layer, are not necessary, and thus cost and environmental loads can be reduced.
(4) Various shapes of the thermosensitive recording layer can be partially and freely arranged to improve design.
(5) A thermosensitive recording layer capable of coloring in several colors is freely arranged to improve design.
(6) In the case where a thermosensitive recording layer is used as a heat seal for a packaging material, a packaging material that does not color can be provided by removing the thermosensitive recording layer from the area of the heat heal to which a high temperature is applied.

As a technique for printing a thermosensitive recording layer according a printing system, for example, proposed is a thermosensitive ink, which includes a leuco dye, a color developer capable of coloring the leuco dye as heated, an acrylic resin serving as a binder, and a toluene serving as a solvent, and can be printed in a printing system and is capable of partial printing (see, for example, PTL 1).

Meanwhile, a phenolic color developer having excellent preservability of background and an image and excellent coloring sensitivity, such as 4,4′-isopropylidenediphenol, has been widely used as a color developer that is an electron-accepting compound of a thermosensitive recording medium. However, use of the phenolic color developer is concerned because the phenolic color developer is an endocrine disruptor. In recent years, various thermosensitive recording media using a color developer having no phenolic skeleton (may be referred to as a (non-phenolic color developer” hereinafter) have been proposed considering the environmental friendliness (see, for example, PTL 2 and PTL 3). The proposed thermosensitive recording layer forming liquids are aqueous dispersion liquids.

### CITATION LIST

### Patent Literature

PTL 1: Japanese Unexamined Patent Application Publication No. 2019-38206
PTL 2: Japanese Unexamined Patent Application Publication No. 2015-150764
PTL 3: Japanese Unexamined Patent Application Publication No. 2014-226848

### SUMMARY OF INVENTION

### Technical Problem

The present disclosure has an object to provide a thermosensitive recording layer forming liquid capable of forming a thermosensitive recording layer that has no tailing, no coating unevenness and has excellent uniformity of background, and a less variation in thickness.

In the present specification, the term “no tailing” means a state where a boundary between a printed area and a non-printed area is clear, and a state of Rank 4 or better in the evaluation grading table of the tailing in FIG. 40, where the area indicated with a dashed line is small.

### Solution to Problem

According to one aspect of the present disclosure, a thermosensitive recording layer forming liquid includes an electron-donating compound, an electron-accepting compound, and a solvent. Solubility of the electron-accepting compound to 100% ethanol at 20° C. is 5% by mass or less.

### Advantageous Effects of Invention

The present disclosure can provide a thermosensitive recording layer forming liquid capable of forming a thermosensitive recording layer that has no tailing, no coating unevenness and has excellent uniformity of background, and a less variation in thickness.

### BRIEF DESCRIPTION OF DRAWINGS

FIG. 1 is a schematic cross-sectional view illustrating an example of the thermosensitive recording medium according to the first embodiment.

FIG. 2 is a schematic cross-sectional view illustrating an example of the thermosensitive recording medium according to the second embodiment.

FIG. 3 is a schematic cross-sectional view illustrating an example of the thermosensitive recording medium according to the third embodiment.

FIG. 4 is a schematic cross-sectional view illustrating an example of the thermosensitive recording medium according to the fourth embodiment.

FIG. 5 is a schematic cross-sectional view illustrating an example of the thermosensitive recording medium according to the fifth embodiment.

FIG. 6 is a schematic cross-sectional view illustrating an example of the thermosensitive recording medium according to the sixth embodiment.

FIG. 7 is a schematic cross-sectional view illustrating an example of the thermosensitive recording medium according to the seventh embodiment.

FIG. 8 is a schematic cross-sectional view illustrating an example of the thermosensitive recording medium according to the eighth embodiment.

FIG. 9 is a schematic cross-sectional view illustrating an example of the thermosensitive recording medium according to the ninth embodiment.

FIG. 10 is a schematic cross-sectional view illustrating an example of the thermosensitive recording medium according to the tenth embodiment.

FIG. 11A is a schematic cross-sectional view illustrating an example of the thermosensitive recording medium according to the eleventh embodiment.

FIG. 11B is a schematic plane view (a surface of a support) illustrating an example of the thermosensitive recording medium according to the eleventh embodiment.

FIG. 12A is a schematic cross-sectional view illustrating an example of the thermosensitive recording medium according to the twelfth embodiment.

FIG. 12B is a schematic plane view (a surface of a support) illustrating an example of the thermosensitive recording medium according to the twelfth embodiment.

FIG. 13A is a schematic cross-sectional view illustrating an example of the thermosensitive recording medium according to the thirteenth embodiment.

FIG. 13B is a schematic plane view (a surface of a support) illustrating an example of the thermosensitive recording medium according to the thirteenth embodiment.

FIG. 14A is a schematic cross-sectional view illustrating an example of the thermosensitive recording medium according to the fourteenth embodiment.

FIG. 14B is a schematic plane view (a surface of a support) illustrating an example of the thermosensitive recording medium according to the fourteenth embodiment.

FIG. 15A is a schematic cross-sectional view illustrating an example of the thermosensitive recording medium according to the fifteenth embodiment.

FIG. 15B is a schematic plane view (a surface of a support) illustrating an example of the thermosensitive recording medium according to the fifteenth embodiment.

FIG. 16A is a schematic cross-sectional view illustrating an example of the thermosensitive recording medium according to the sixteenth embodiment.

FIG. 16B is a schematic plane view (a surface of a support) illustrating an example of the thermosensitive recording medium according to the sixteenth embodiment.

FIG. 17A is a schematic cross-sectional view illustrating an example of the thermosensitive recording medium according to the seventeenth embodiment.

FIG. 17B is a schematic plane view (a surface of a support) illustrating an example of the thermosensitive recording medium according to the seventeenth embodiment.

FIG. 17C is a schematic plane view (a back surface of a support) illustrating an example of the thermosensitive recording medium according to the seventeenth embodiment.

FIG. 18A is a schematic cross-sectional view illustrating an example of the thermosensitive recording medium according to the eighteenth embodiment.

FIG. 18B is a schematic plane view (a surface of a support) illustrating an example of the thermosensitive recording medium according to the eighteenth embodiment.

FIG. 18C is a schematic plane view (a back surface of a support) illustrating an example of the thermosensitive recording medium according to the eighteenth embodiment.

FIG. 19A is a schematic cross-sectional view illustrating an example of the thermosensitive recording medium according to the nineteenth embodiment.

FIG. 19B is a schematic plane view (a surface of a support) illustrating an example of the thermosensitive recording medium according to the nineteenth embodiment.

FIG. 19C is a schematic plane view (a back surface of a support) illustrating an example of the thermosensitive recording medium according to the nineteenth embodiment.

FIG. 20A is a schematic cross-sectional view illustrating an example of the thermosensitive recording medium according to the twentieth embodiment.

FIG. 20B is a schematic plane view (a surface of a support) illustrating an example of the thermosensitive recording medium according to the twentieth embodiment.

FIG. 20C is a schematic plane view (a back surface of a support) illustrating an example of the thermosensitive recording medium according to the twentieth embodiment.

FIG. 21A is a schematic cross-sectional view illustrating an example of the thermosensitive recording medium according to the twenty-first embodiment.

FIG. 21B is a schematic plane view (a surface of a support) illustrating an example of the thermosensitive recording medium according to the twenty-first embodiment.

FIG. 21C is a schematic plane view (a back surface of a support) illustrating an example of the thermosensitive recording medium according to the twenty-first embodiment.

FIG. 22A is a schematic cross-sectional view illustrating an example of the thermosensitive recording medium according to the twenty-second embodiment.

FIG. 22B is a schematic plane view (a surface of a support) illustrating an example of the thermosensitive recording medium according to the twenty-second embodiment.

FIG. 22C is a schematic plane view (a back surface of a support) illustrating an example of the thermosensitive recording medium according to the twenty-second embodiment.

FIG. 23A is a schematic cross-sectional view illustrating an example of the thermosensitive recording medium according to the twenty-third embodiment.

FIG. 23B is a schematic plane view (a surface of a support) illustrating an example of the thermosensitive recording medium according to the twenty-third embodiment.

FIG. 24A is a schematic cross-sectional view illustrating an example of the thermosensitive recording medium according to the twenty-fourth embodiment.

FIG. 24B is a schematic plane view (a surface of a support) illustrating an example of the thermosensitive recording medium according to the twenty-fourth embodiment.

FIG. 25A is a schematic cross-sectional view illustrating an example of the thermosensitive recording medium according to the twenty-fifth embodiment.

FIG. 25B is a schematic plane view (a surface of a support) illustrating an example of the thermosensitive recording medium according to the twenty-fifth embodiment.

FIG. 25C is a schematic plane view (a back surface of a support) illustrating an example of the thermosensitive recording medium according to the twenty-fifth embodiment.

FIG. 26A is a schematic cross-sectional view illustrating an example of the thermosensitive recording medium according to the twenty-sixth embodiment.

FIG. 26B is a schematic plane view (a surface of a support) illustrating an example of the thermosensitive recording medium according to the twenty-sixth embodiment.

FIG. 27A is a schematic cross-sectional view illustrating an example of the thermosensitive recording medium according to the twenty-seventh embodiment.

FIG. 27B is a schematic plane view (a surface of a support) illustrating an example of the thermosensitive recording medium according to the twenty-seventh embodiment.

FIG. 28A is a schematic cross-sectional view illustrating an example of the thermosensitive recording medium according to the twenty-eighth embodiment.

FIG. 28B is a schematic plane view (a surface of a support) illustrating an example of the thermosensitive recording medium according to the twenty-eighth embodiment.

FIG. 29A is a schematic cross-sectional view illustrating an example of the thermosensitive recording medium according to the twenty-ninth embodiment.

FIG. 29B is a schematic plane view (a surface of a support) illustrating an example of the thermosensitive recording medium according to the twenty-ninth embodiment.

FIG. 30A is a schematic cross-sectional view illustrating an example of the thermosensitive recording medium according to the thirtieth embodiment.

FIG. 30B is a schematic plane view (a surface of a support) illustrating an example of the thermosensitive recording medium according to the thirtieth embodiment.

FIG. 31A is a schematic cross-sectional view illustrating an example of the thermosensitive recording medium according to the thirty-first embodiment.

FIG. 31B is a schematic plane view (a surface of a support) illustrating an example of the thermosensitive recording medium according to the thirty-first embodiment.

FIG. 32A is a schematic cross-sectional view illustrating an example of the thermosensitive recording medium according to the thirty-second embodiment.

FIG. 32B is a schematic plane view (a surface of a support) illustrating an example of the thermosensitive recording medium according to the thirty-second embodiment.

FIG. 33 is a schematic view illustrating an example of an image recording device used for the image recording method of the present disclosure.

FIG. 34 is a schematic view illustrating another example of the image recording device used for the image recording method of the present disclosure.

FIG. 35 is a view illustrating an alignment state of a laser array of the image recording device used for the image recording method of the present disclosure.

FIG. 36A is a schematic view illustrating an example of a gravure roll used for gravure printing performed in Examples.

FIG. 36B is a schematic view illustrating the layout of the gravure printing in Examples.

FIG. 37 is a schematic view illustrating an example of a flexographic printing plate used for the flexographic printing performed in Examples.

FIG. 38 is a view illustrating an evaluation grading table of background evenness.

FIG. 39 is a view illustrating an evaluation grading table of image evenness.

FIG. 40 is a view illustrating an evaluation grading table of tailing.

### DESCRIPTION OF EMBODIMENTS

### (Thermosensitive Recording Layer Forming Liquid)

The thermosensitive recording layer forming liquid of the present disclosure includes an electron-donating compound, an electron-accepting compound, and a solvent. The solubility of the electron-accepting compound to 100% ethanol at 20° C. is 5% by mass or less. The thermosensitive recording layer forming liquid may further include other components according to the necessity.

The thermosensitive recording layer forming liquid of the present disclosure is used for forming the thermosensitive recording medium of the present disclosure. The phrase “used for forming the thermosensitive recording medium of the present disclosure” means being used for forming a thermosensitive recording layer of the thermosensitive recording medium of the present disclosure.

In the art, a thermosensitive recording layer forming liquid for use is typically an aqueous dispersion liquid. Therefore, the thermosensitive recording layer forming liquid does not smoothly spread when the thermosensitive recording layer forming liquid is applied by printing. Accordingly, there are problems that leveling is low, tailing and coating unevenness tend to occur, a thickness of the printed thermosensitive recording layer varies significantly, and coating unevenness occurs to cause unevenness of background. When a thermosensitive recording layer is partially disposed, moreover, the flow of the thermosensitive recording layer forming liquid is not sufficiently controlled to form into a shape to be formed, blurring of a shape or tailing may occur.

In the art, moreover, an aromatic solvent, such as toluene, is used, but use of toluene is restricted in the printing industry in order to reduce environmental loads through discharge of VOC.

Moreover, a thermosensitive recording layer forming liquid known in the art is an aqueous dispersion liquid. If the solvent for use is changed to an alcohol-based solvent or ester-based solvent, other than the aromatic solvent, in order to adjust printing conditions, solubility of the electron-accepting compound increases, and the ratio of the electron-accepting compound present as particles in the solvent reduces to form a state like an electron-accepting compound solution. Therefore, there are problems that the contact probability with the electron-donating compound increases, a coloring reaction between the electron-donating compound and the electron-accepting compound progresses overtime, and so-called a “liquid fogging” phenomenon of the thermosensitive recording layer forming liquid.

Therefore, the thermosensitive recording forming liquid of the present disclosure include an electron-donating compound, an electron-accepting compound, and a solvent, where a solubility of the electron-accepting compound to 100% ethanol at 20° C. is 5% by mass less. As a result, the proportion of the electron-accepting compound present as particles in the solvent increases, the contact probability with the electron-donating compound reduces, and a coloring reaction between the electron-donating compound and the electron-accepting compound is prevented overtime. Therefore, the “liquid fogging” phenomenon is significantly suppressed. Moreover, the thermosensitive recording layer forming liquid of the present disclosure can form a thermosensitive recording layer having a less variation in thickness, has no tailing and coating unevenness, and has excellent background uniformity.

The thermosensitive recording layer formed of the thermosensitive recording layer forming liquid of the present disclosure can be obtained by applying a thermosensitive recording layer forming liquid onto a support through printing, where the thermosensitive recording layer forming liquid includes an electron-donating compound, an electron-accepting compound solubility of which to 100% ethanol at 20° C. is 5% by mass or less, and a solvent.

In the present disclosure, the thermosensitive recording layer forming liquid is preferably applied onto a partial region of the support. Specifically, the thermosensitive recording layer forming liquid is applied to an area of the support, in which image recording is desired, to form a thermosensitive recording layer. The “partial region” of the support means a partial area, and the area of the thermosensitive recording layer is less than 100% relative to the total area of the surface of the support. A shape, size, number, and arrangement of the thermosensitive recording layer are not particularly limited and may be appropriately selected depending on the intended purpose.

The thermosensitive recording layer forming liquid of the present disclosure includes an electron-donating compound, an electron-accepting compound, and a solvent, and preferably further includes a surfactant, a photothermal conversion material, and a binder resin. The thermosensitive recording layer forming liquid may further include other components according to the necessity.

### <Electron-Donating Compound>

The electron-donating compound is not particularly limited, and may be appropriately selected from electron-donating compounds generally used for thermosensitive recording media depending the intended purpose. Examples of the electron-donating compound include leuco compounds, such as triphenylmethane-based dyes, fluoran-based dyes, phenothiazine-based dyes, auramine-based dyes, spiropyran-based dyes, and indolinophthalide-based dyes. The above-listed examples may be used alone or in combination.

Examples of the electron-accepting compound of a black dye include
6-(diethylamino)-2-[3-(trifluoromethyl)anilino]spiro[9H-xanthene-9,3′(1′H)-isobenzofuran]-1′-one,
2′-anilino-3′-methyl-6′-(dipentylamino)spiro[isobenzofuran-1(3H),9′-[9H]xanthen]-3-one, 2′-anilino-6′-dibutylamino-3′-methylspiro[phthalide-3,9′-[9H]xanthene,
2′-anilino-6′-(N-ethyl-N-isopentylamino)-3′-methylspiro[phthalide-3,9′-[9H]xanthene],
2-(phenylamino)-3-methyl-6-[ethyl(p-tolyl)amino]spiro[9H-xanthene-9,1′(3′H)-isobenzofuran]-3′-one, 3-diethylamino-6-methyl-7-anilinofluoran, and
3-dibutylamino-6-methyl-7-anilinofluoran.

Examples of the electron-accepting compound of a red dye include
6′-(diethylamino)-1′,2′-benzfluoran,
9-(N-ethyl-N-isopentylamino)spiro[benzo[a]xanthene-12,3′-phthalide],
2′-methyl-6′-(N-p-tolyl-N-ethylamino)spiro[isobenzofuran-1(3H),9′-[9H]xanthen]-3-one, 2′-chloro-6′-(diethylamino)spiro[isobenzofuran-1(3H),9′-[9H]xanthen]-3-one,
6′-(dibutylamino)-2′-bromo-3′-methylspiro[phthalide-3,9′-xanthene], and
3,3-bis(1-n-butyl-2-methyl-3-indolyl)phthalide.

Examples of the electron-accepting compound of a blue dye include
3-[4-(diethylamino)-2-hexyloxyphenyl]-3-(1-ethyl-2-methylindol-3-yl)-4-azaphthalide,
3-(4-diethylamino-2-ethoxyphenyl)-3-(1-ethyl-2-methylindol-3-yl)-4-azaphthalide, and
3′,6′-bis(diphenylamino)spiro[phthalide-3,9′-xanthene].

Examples of the electron-accepting compound of a green dye include
1-ethyl-8-[N-ethyl-N-(4-methylphenyl)amino]-2,2,4-trimethyl-1,2-dihydrospiro[111H-chromeno[2,3-g]quinolone-11,3′-phthalide],
2′-(dibenzylamino)-6′-(diethylamino)fluoran, and
2′-(N-phenyl-N-methylamino)-6′-(N-p-tolyl-N-ethylamino)spiro[isobenzofuran-1(3H),
9′-[9H]xanthen]-3-one.

Examples of the electron-accepting compound of a yellow or orange dye include F.Color Yellow-17, Orange 100, and Orange-DCF.

The above-listed electron-donating compounds may be used alone or in combination.

The 50% cumulative volume particle diameter (D₅₀) of the electron-donating compound is preferably 0.05 micrometers or greater but 0.5 micrometers or less, and more preferably 0.1 micrometers or greater but 0.3 micrometers or less.

For example, the 50% cumulative volume particle diameter (D₅₀) of the electron-donating compound can be measured by means of a laser diffraction/scattering particle size analyzer (device name: LA-960, available from Horiba, Ltd.).

An amount of the electron-donating compound is not particularly limited and may be appropriately selected depending on the intended purpose. The amount of the electron-donating compound is 5% by mass or greater but 40% by mass or less, and more preferably 10% by mass or greater but 30% by mass or less, relative to a total amount of the thermosensitive recording layer forming liquid.

### <Electron-Accepting Compound>

The electron-accepting compound is not particularly limited as long as the electron-accepting compound accepts electrons, and may be appropriately selected depending on the intended purpose. The electron-accepting compound is preferably a color developer.

The color developer is not particularly limited as long as solubility of the color developer to 100% ethanol at 20° C. is 5% by mass or less, and may be appropriately selected depending on the intended purpose. Examples of the color developer include a non-phenolic color developer, and a bisphenol-based color developer. Among the above-listed examples, a non-phenolic color developer is preferable. The solubility of the electron-accepting compound to 100% ethanol at 20° C. is preferably 4% by mass or less, more preferably 3% by mass or less, and particularly preferably 1% by mass or less.

### <Measurement of Solubility of Electron-Accepting Compound to Ethanol>

### «1. Preparation of Saturated Solution»

(1) In the environment of 20° C.±3° C., about 100 g of a solvent (100% ethanol) is prepared in a 150 mL to 300 mL beaker.
(2) While stirring a stirrer or a stirring rod, an electron-accepting compound is added gradually until insoluble matter of the electron-accepting compound appears at the bottom of the beaker.
(3) The resultant is left to stand for 1 hour or longer with a lid placed on top of the beaker.
(4) If the insoluble matter is completely disappeared by stirring with the stirring rod, the processes (2) to (4) are repeated.
(5) If the insoluble matter is remained after standing for 1 hour or longer, it is determined that preparation of a saturated solution is completed.

### «2. Measurement of Solubility»

A weight (A) of an aluminium cup is weighed with the minimum unit of 1 mg or less.

The part of the transparent supernatant liquid of the saturated solution prepared in 1 is collected by a pipette, and the collected liquid is placed in the aluminium cup (about 0.8 g to about 1.3 g in weight) and a weight of the liquid is weighed with the minimum unit of 1 mg or less.

The measurement is promptly performed in order to prevent inclusion of dusts etc.

The aluminium cup in which the liquid is collected is placed in a dryer (120° C.±10° C.). Alternatively, the aluminium cup in which the liquid is collected is placed on a hot plate (120° C.±10° C.) in an area where a local ventilation is installed.

The solvent is evaporated from the liquid for 25 minutes or longer (a lid is placed to prevent inclusion of dusts when a hot plate is used).

The aluminium cup is removed from the drier or hot plate, and is left to stand for 1 minute or longer indoor, followed by weighing the total amount (C) with the minimum unit of 1 mg or less.

Based on the measurement results of A, B, and C above, the solubility of the electron-accepting compound to ethanol is calculated according to the following mathematical equation 1.

Solubility (% by mass)=[(C−A)/B]×100 Mathematical Equation 1

The non-phenolic color developer means that a color developer does not have a phenol skeleton. Since the non-phenolic color developer is not regarded as an endocrine disruptor, unlike a phenolic color developer, the non-phenolic color developer is desirable in view of environmental friendliness.

The non-phenolic color developer is at least one selected from the group consisting of compounds that include a linking group that is a (thio)urea group (—NH—CX—NH—) (where X is O or S) or a sulfonyl(thio)urea group (—SO₂—NH—CX—NH—) (where X is O or S), and a linking group that is a urethane group (—NHCOO—), an amide group (—NHCO—), a sulfonyl group (—SO₂—), or a sulfonylamide group (—SO₂NH—), and has a structure where aromatic groups are bonded via the linking groups. The non-phenolic color developer is more preferably at least one selected from the group consisting compounds that include a linking group that is an urea group (—NH—CO—NH—) or a sulfonylurea group (—SO₂—NH—CO—NH—), and a linking group that is an amide group (—NHCO—), a sulfonyl group (—SO₂—), or a sulfonylamide group (—SO₂NH—), and has a structure where aromatic groups are bonded via the linking groups.

As the electron-accepting compound, various materials capable of reacting with the electron-donating compound to color the electron-donating compound as heated may be used. The electron-accepting compounds may be used alone or in combination.

The electron-accepting compound is not particularly limited, and any of known electron-accepting compounds may be used as long as solubility of an electron-accepting compound to ethanol at 20° C. is 5% by mass or less. Examples of the known electron-accepting compounds include sulfur-containing bisphenol compounds, 4-hydroxybenzoic acid esters, benzoic acid salts, salicylic acid metal salts, hydroxysulfones, polyvalent metals of hydroxysulfones, hydroxyl naphthoic acid esters, trihalomethylsulfones, sulfonyl ureas, and diphenylsulfone crosslinked compound.

The electron-accepting compound is preferably any of Compounds (I) to (VI) below.

### (Compound (I))

Compound (I) is represented by General Formula (I).

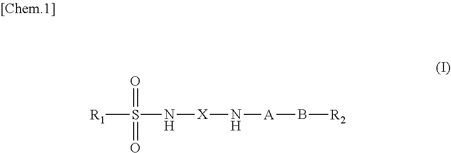

In General Formula (I), R₁ is a phenyl group that is not substituted or substituted with a C1-C8 alkyl group, a C1-C8 alkoxy group, or a halogen atom; X is a group represented by —C(═O)—; and A is a C1-C8 alkyl group that is not substituted or substituted with a C1-C8 alkyl group or a halogen atom, a C1-C8 alkoxy group that is substituted with a C1-C8 alkoxy group or a halogen atom, or a phenylene group that is substituted with a C1-C8 alkylsulfonyl group, a halogen atom, a phenyl group, a phenoxy group, or a phenoxycarbonyl group.

B is any one selected from the following linking groups:

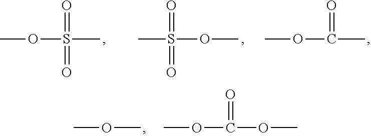

R₂ is a C1-C4 alkyl group, a C1-C4 alkyl group substituted with a halogen atom, a phenyl group that is unsubstituted or substituted with a C1-C4 alkyl group or a halogen atom, or a benzyl group that is unsubstituted or substituted with a C1-C4 alkyl group or a halogen atom.

When B is not the linking group represented by —O—SO₂—, R₂ is an unsubstituted or substituted phenyl group or an unsubstituted or substituted C1-C8 alkyl group. When B is the linking group represented by —O—, R₂ is not an alkyl group.

Compound (I) is particularly preferably the compound represented by the following structural formula.

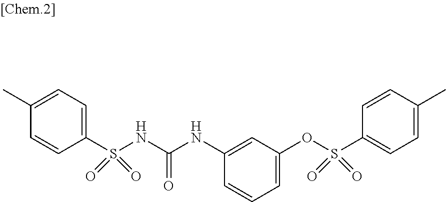

### (Compound (II))

Compound (II) is represented by General Formula (II) below.

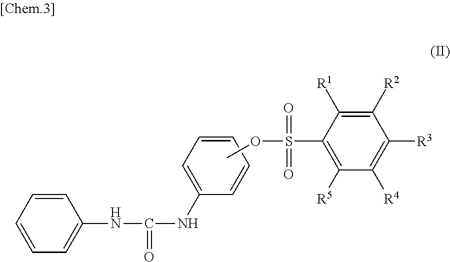

In General Formula (II), R¹ to R⁵ are each independently hydrogen atom, a halogen atom, a nitro group, an amino group, an alkyl group, an alkoxy group, an aryloy group, an alkylcarbonyloxy group, an arylcarbonyloxy group, an alkylcarbonylamino group, an arylcarbonylamino group, an alkylsulfonylamino group, an arylsulfonylamino group, a monoalkylamino group, a dialkylamino group, or an arylamino group.

Compound (II) is particularly preferably the compound represented by the following structural formula.

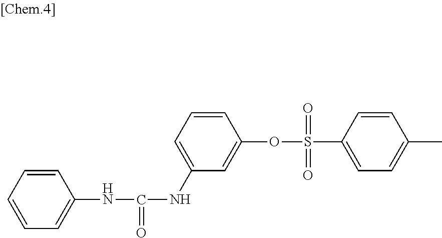 [SMILES: Cc1ccc(S(=O)(=O)Oc2cccc(NC(=O)Nc3ccccc3)c2)cc1]

### (Compound (III))

Compound (III) is represented by General Formula (III) below.

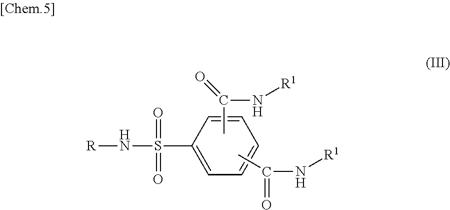

In General Formula (III), R and R¹ are each independently selected from the groups (1) to (5).
(1) a hydrogen atom, (2) a straight-chain or branched-chain C1-C18 alkyl group, (3) R¹¹OR¹²-(where R¹¹ and R¹² are each independently a straight-chain or branched-chain C1-C8 alkyl group), (4) (R¹³)₂N—R¹² (where R¹³ is a straight-chain or branched-chain C1-C8 alkyl group, or a 5 or 6-membered ring formed by bonding the straight-chain or branched-chain C1-C8 alkyl group with nitrogen, and R¹² is a straight-chain or branched-chain C1-C8 alkyl group), and (5) a radical represented by General Formula (A) below (where R², R³, R⁴, R⁵, and R⁶ are each independently selected from (i) to (vii) below.
(i) a hydrogen atom, (ii) a straight-chain or branched-chain C1-C8 alkyl group, (iii) —NH—C(═O)—R¹⁴ or —C(═O)—NH—R¹⁴ (R¹⁴ is a straight-chain or branched-chain C1-C8 alkyl group), (iv) —C(═O)OR¹⁵ (where R¹⁵ is a straight-chain or branched-chain C1-C8 alkyl group), (v) a halogen atom, (vi) a combination of R² and R³ and/or a combination of R⁴ and R⁵, or a combination of R³ and R⁴ and/or a combination of R⁵ and R⁶, or a combination of R² and R³ and a combination of R⁵ and R⁶ form a hydrocarbon radical including 3 or 4 carbon atoms, and (vii) X is a single bond, or a branched or unbranched C1-C8 alkylene group optionally including one or more oxygen atoms.

### (General Formula A)

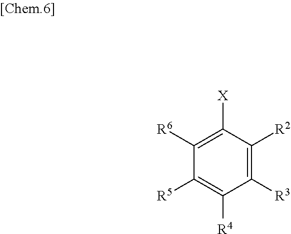

Compound (III) is particularly preferably the compound represented by the following structural formula.

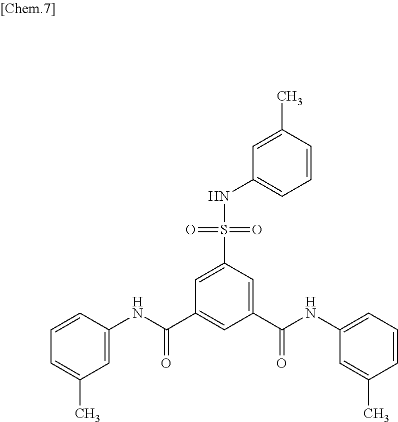 [SMILES: Cc1cccc(NC(=O)c2cc(C(=O)Nc3cccc(C)c3)cc(S(=O)(=O)Nc3cccc(C)c3)c2)c1]

### (Compound (IV))

Compound (IV) is represented by any of General Formulae (IV)-1 to (IV)-3.

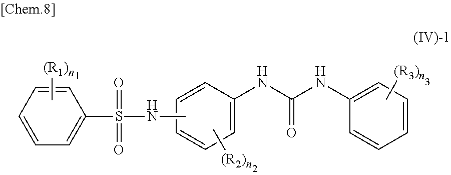

In General Formula (IV)-1, R₁ to R₃ are each independently a hydrogen atom, a halogen atom, a nitro group, a C1-C6 alkyl group, a C1-C6 alkoxy group, a C2-C6 alkenyl group, a C1-C6 fluoroalkyl group, N(R₄)₂ group (where R₄ is a hydrogen atom, a phenyl group, a benzyl group, or a C1-C6 alkyl group), NHCOR₅ (where R₅ is a C1-C6 alkyl group), a phenyl group that may be substituted, or a benzyl group that may be substituted; n1 and n3 are each independently an integer of from 1 through 5; and n2 is an integer of from 1 through 4.

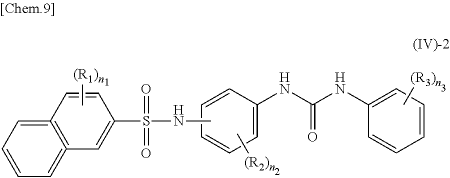

In General Formula (IV)-2, R1 to R3 are identical to R₁ to R₃ of General Formula (I); n2 and n3 are identical to n2 and n3 of General Formula (IV)-1; and n4 is an integer of from 1 through 7.

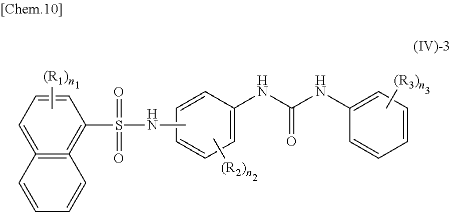

In General Formula (IV)-3, R1 to R3 are identical to R1 to R3 of General Formula (IV)-1; and n2, n3, and n4 are identical to n2, n3, and n4 of General Formulae (IV)-1 and (IV)-2.

Among Compounds (IV) represented by General Formulae (IV)-1 to (IV)-3, Compound (IV) is particularly preferably the compound having the structure represented by Structural Formula (IV) below.

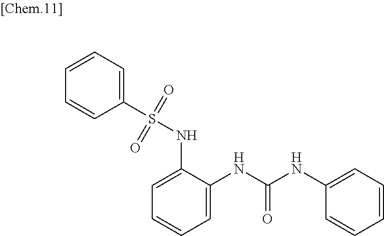

### Structural Formula (IV)

### (Compound (V))

Compound (V) is represented by General Formula (V) below.

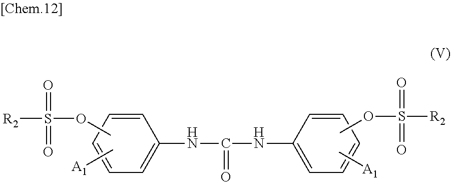

In General Formula (V), R₂ is a straight-chain, branched-chain, or alicyclic C1-C12 alkyl group, a C7-C12 aralkyl group or C6-C12 aryl group that is unsubstituted or substituted with a C1-C12 alkyl group, a C1-C12 alkoxy group, a C6-C12 aryl group, or a halogen atom, where two or more R₂ may be identical to or different from each other. A₁ is a hydrogen atom or a C1-C4 alkyl group, where two or more A₁ may be identical to or different from each other.

Among the compounds represented by General Formula (V), the compound represented by Structural Formula (V) below is particularly preferable.

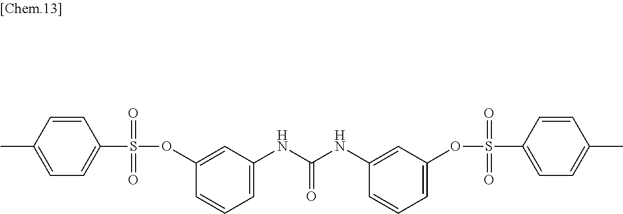

### Structural Formula (V)

### (Compound (VI))

Compound (VI) is represented by any of General Formulae (VI-1) to (VI-7).

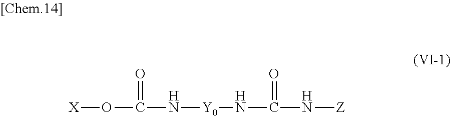

In General Formula (VI-1), X and Z are each an aromatic compound residue, which may have a substituent; and Y₀ is at least one selected from the group consisting of a tolylene group, a xylylene group, a naphthylene group, -Φ-CH₂-Φ- group, and the unit represented by Structural Formula (1) below, where -Φ- represents a phenylene group.

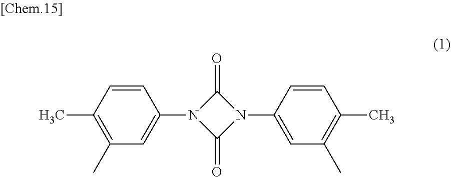

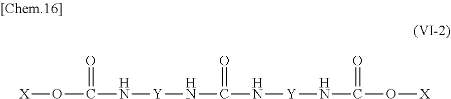

In General Formula (VI-2), X and Y are each an aromatic compound residue, which may have a substituent.

$$Void ratio ( \% ) = ( inner diameter of hollow particle / outer diameter of hollow particle ) \times 100$$

In General Formula (VI-3), X and Y are each an aromatic compound residue; A is a bivalent or higher aromatic compound residue; and n is an integer of 2 or greater, where each of the residues may have a substitute.

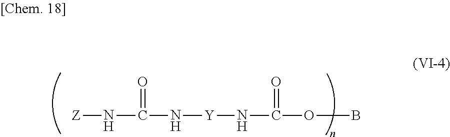

In General Formula (VI-4), Z and Y are each an aromatic compound residue; B is a divalent or higher aromatic compound residue; and n is an integer of 2 or greater, where each residue may have a substituent.

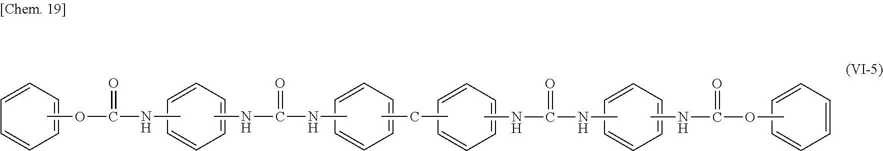

In General Formula (VI-5), a hydrogen atom of a benzene ring may be substituted with an aliphatic compound residue that may include a substituent; C is one selected from the group consisting of —SO₂—, —O—, —(S)n-, —(CH₂)n-, —CO—, —CONH—, and the groups represented by the following structural formulae, or may not exist; and n is 1 or 2.

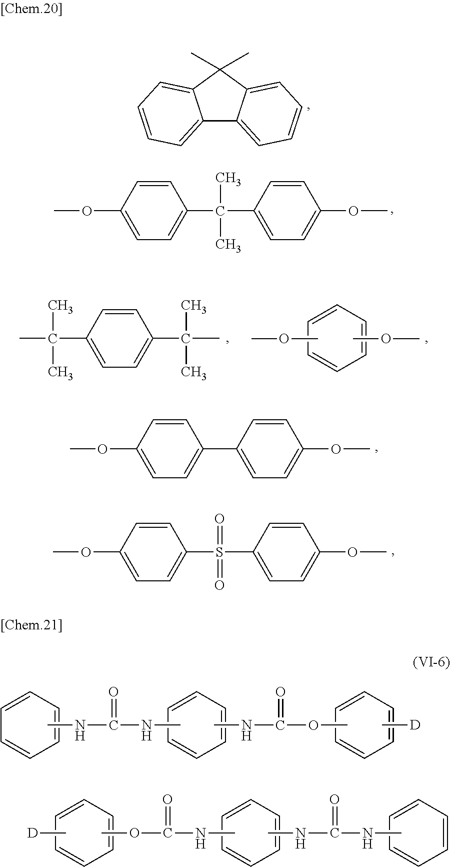

In General Formula (VI-6), a hydrogen atom of a benzene ring may be substituted; an aliphatic compound residue may have a substituent; D is at least one or none selected from the group consisting of —SO₂—, —O—, —(S)n-, —(CH₂)n-, —CO—, —CONH—, —NH—, —CH(COOR₁)—, —C(CF₃)₂—, and —CR₂R₃—, where R₁, R₂, and R₃ are each an alkyl group; and n is 1 or 2.

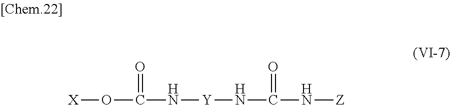

In General Formula (VI-7), X, Y, and Z are each an aromatic compound residue, and each residue may include a substituent.

Among Compounds (VI-1) to (VI-7), the compound represented by Structural Formula (VI) below is particularly preferable.

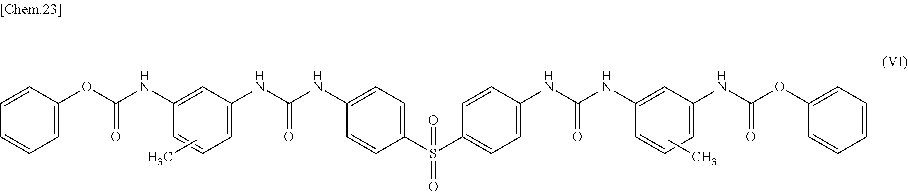

An amount of the electron-accepting compound is not particularly limited and may be appropriately selected depending on the intended purpose. The amount of the electron-accepting compound is 1 part by mass or greater but 20 parts by mass or less, and more preferably 2 parts by mass or greater but 10 parts by mass or less, relative to 1 part by mass of the electron-donating compound.

### <Solvent>

Examples of the solvent include water, aromatic solvents, ester solvents, ketone solvents, alcohol solvents, aliphatic hydrocarbon, glycol solvents, paraffin solvents, petroleum solvents including as a main component naphthene and including 1% or less of an aromatic component, and mixed solvents thereof. Among the above-listed examples, an alcohol solvent, an ester solvent, or a mixed solvent of water and alcohol are suitably used considering solubility of the electron-accepting compound and reduction in the environmental load. An aromatic solvent, such as toluene, has low dissolvability of an electron-accepting compound, but use of the aromatic solvent is limited in the printing industry for the purpose of reducing environmental loads through discharge of VOC.

Examples of the alcohol solvent include methanol, ethanol, isopropyl alcohol, npropyl alcohol, and butanol. Among the above-listed examples, ethanol is particularly preferable.

Examples of the ester solvent include ethyl acetate, propyl acetate, isopropyl acetate, isobutyl acetate, butyl acetate, isoamyl acetate, amyl acetate, hexyl acetate, phenyl acetate, and benzyl acetate.

Examples of the water include pure water, such as ion-exchanged water, ultrafiltration water, Mill Q water, and distilled water, and ultra-pure water.

In the present disclosure, a mixed solvent of the alcohol and water may be used. Since the electron-accepting compound having the solubility to the ethanol in the above-described range is used, a “liquid fogging” phenomenon is significantly suppressed overtime. The “liquid fogging” can be further suppressed by using a mixed solvent including water, and a cycle time of the thermosensitive recording layer forming liquid can be prolonged, contributing to improvement in productivity.

Considering leveling, the mixed solvent preferably includes the alcohol solvent in the amount of 20% by mass or greater, and more preferably 40% by mass or greater.

### <Photothermal Conversion Material>

The photothermal conversion material is a material that absorbs laser light to convert the absorbed light into heat. The photothermal conversion material is roughly classified into an inorganic material and an organic material.

Examples of the inorganic material include particles of carbon black, metal boride, and metal oxide of Ge, Bi, In, Te, Se, Cr, etc. Among the above-listed examples, the metal boride and the metal oxide are preferable because light absorption in a near infrared wavelength range is large and light absorption in a visible wavelength range is small. For example, the metal boride and the metal oxide are preferably at least one selected from the group consisting of hexaboride, a tungsten oxide compound, antimony tin oxide (ATO), indium tin oxide (ITO), and zinc antimonite.

Examples of the hexaboride include LaB₆, CeB₆, PrB₆, NdB₆, GdB₆, TbB₆, DyB₆, HoB₆, YB₆, SmB₆, EuB₆, ErB₆, TmB₆, YbB₆, LuB₆, SrB₆, CaB₆, and (La,Ce)B₆.

Examples of the tungsten oxide compound include particles of tungsten oxide represented by a general formula: WyOz (with the proviso that W is tungsten, O is oxygen, and 2.2≤z/y≤2.999), and particles of complex tungsten oxide represented by a general formula: WyOz (with the proviso that M is at least one element selected from the group consisting of H, He, alkali metals, alkaline earth metals, rare earth element, Mg, Zr, Cr, Mn, Fe, Ru, Co, Rh, Ir, Ni, Pd, Pt, Cu, Ag, Au, Zn, Cd, Al, Ga, In, Tl, Si, Ge, Sn, Pb, Sb, B, F, P, S, Se, Br, Te, Ti, Nb, V, Mo, Ta, Re, Be, Hf, Os, Bi, and I, W is tungsten, O is oxygen, 0.001≤x/y≤1, and 2.2≤z/y≤3.0) (see International Publication No. WO2005/037932 and Unexamined Japanese Patent Application Publication No. 2005-187323). Among the above-listed examples, tungsten oxide including cesium is particularly preferable because absorption in a near infrared wavelength range is large and absorption in a visible wavelength range is small. Among the antimony tin oxide (ATO), moreover, the indium tin oxide (ITO), and the zinc antimonate, ITO is preferable because absorption in a near infrared wavelength range is large and absorption in a visible wavelength range is small.

The above-listed materials may be formed into a layer by vacuum vapor deposition, or adhering a particulate material with a resin, etc.

Various dyes are appropriately used as the organic material depending on a wavelength of light to be absorbed. In the case where a semiconductor laser is used as a light source, a near infrared absorbing dye having an absorption peak at from about 600 nm through about 1,200 nm is used. Specific examples of the near infrared absorbing dye include a cyanine dye, a quinone-based dye, a quinolone derivative of indonaphthol, a phenylenediamine-based nickel complex, and a phthalocyanine-based dye.

The above-listed photothermal conversion material may be used alone or in combination.

The photothermal conversion material may be included in the thermosensitive recording layer or another layer that is not the thermosensitive recording layer. In the case where the photothermal conversion material is included in a layer that is not the thermosensitive recording layer, the layer including the photothermal conversion material is preferably disposed next to the thermosensitive recording layer.

An amount of the photothermal conversion material is preferably 0.1% by mass or greater but 10% by mass or less, and more preferably 0.3% by mass or greater but 5% by mass or less, relative to a total amount of the thermosensitive recording layer forming liquid

### -Surfactant-

The thermosensitive recording layer forming liquid may include a surfactant for the purpose of adjusting the surface tension of the thermosensitive recording layer forming liquid of the present disclosure to precisely form partial coating into a desired shape.

The surfactant is not particularly limited and may be appropriately selected depending on the intended purpose. Examples of the surfactant include an anionic surfactant, a nonionic surfactant, an amphoteric surfactant, and a fluoro surfactant.

Examples of the anionic surfactant include polyoxyethylene alkyl ether acetic acid salt, dodecyl benzene sulfonic acid salt, lauric acid salt, and polyoxyethylene alkyl ether sulfate salt. Above-listed examples may be used alone or in combination.

Examples of the nonionic surfactant include an acetylene glycol-based surfactant, polyoxyethylene alkyl ether, polyoxyethylene alkylphenyl ether, polyoxyethylene alkyl ester, and polyoxyethylene sorbitan fatty acid ester. The above-listed examples may be used alone or in combination.

Examples of the acetyleneglycol-based surfactant include 2,4,7,9-tetramethyl-5-decyne-4,7-diol, 3,6-dimethyl-4-octyne-3,6-diol, 3,5-dimethyl-1-hexyne-3-diol, and 2,5,8,11-tetramethyl-6-dodecyne-5,8-diol. The above-listed examples may be used alone or in combination.

### -Binder Resin-

The binder resin is not particularly limited and may be appropriately selected depending on the intended purpose. Examples of the binder resin include a thermoplastic resin, a thermoset resin, and a photocurable resin. The characteristics of the above-listed resins are not limited, and the binder resin may be a water-soluble resin, a water-dispersible resin, or a solvent-soluble resin.

Examples of the binder resin include: acryl resins; polyvinyl alcohol resins; starch or derivatives of starch; cellulose derivatives such as hydroxymethyl cellulose, hydroxyethyl cellulose, carboxymethyl cellulose, methyl cellulose, and ethyl cellulose; water-soluble polymers such as sodium polyacrylate, polyvinyl pyrrolidone, acrylamide-acrylic acid ester copolymers, styrene-acryl copolymers, acrylamide-acrylic acid ester-methacrylic acid terpolymers, styrene-maleic anhydride copolymer alkali salts, isobutylene-maleic anhydride copolymer alkali salts, polyacrylamide, sodium alginate, gelatin, and casein; emulsions of, for example, polyvinyl acetate, polyurethane, polyacrylic acid, polyacrylic acid ester, vinyl chloride-vinyl acetate copolymers, polybutyl methacrylate, and ethylene-vinyl acetate copolymers; and latexes (aqueous emulsions) of, for example, styrene-butadiene copolymers and styrene-butadiene-acrylic copolymers. Above-listed examples may be used alone or in combination. Among the above-listed examples, an acryl resin and a styrene-acryl copolymer are preferable when transparency is desired.

### <Other Components>

Examples of the above-mentioned other components include auxiliary additives, thermofusible materials, lubricants, filler, ultraviolet absorbers, antioxidants, sensitizers, and photo stabilizers.

As the auxiliary additive, for example, various hindered phenol compounds or hindered amine compounds that have electron-accepting property but have relatively low coloring capability may be added.

Examples of the auxiliary additives include 2,2′-methylenebis(4-ethyl-6-tertiary butylphenol), 4,4′-butylidene bis(6-tertiary butyl-2-methylphenol), 1,1,3-tris(2-methyl-4-hydroxy-5-tertiary butylphenyl)butane, 1,1,3-tris(2-methyl-4-hydroxy-5-cyclohexylphenyl)butane, 4,4′-thiobis(6-tertiary butyl-2-methylphenol), tetrabromo bisphenol A, tetrabromo bisphenol S, 4,4-thiobis(2-methylphenol), 4,4′-thiobis(2-chlorophenol), tetrakis(1,2,2,6,6-pentamethyl-4-piperidyl)-1,2,3,4-butane tetracarboxylate, and tetrakis(1,2,2,6,6-tetramethyl-4-piperidyl)-1,2,3,4-butane tetracarboxylate. Above-listed examples may be used alone or in combination.

### -Thermofusible Material-

fatty acids (e.g., stearic acid and behenic acid), fatty acid amides (e.g., stearic acid amide and palmitic acid amide), fatty acid metal salts (e.g., zinc stearate, aluminum stearate, calcium stearate, zinc palmitate, and zinc behenate), p-benzyl biphenyl, terphenyl, triphenylmethane, benzyl p-benzyloxybenzoate, β-benzyloxynaphthalene, phenyl β-naphthoate, phenyl 1-hydroxy-2-naphthoate, methyl 1-hydroxy-2-naphthoate, diphenyl carbonate, glycol carbonate, dibenzyl terephthalate, dimethyl terephthalate, 1,4-dimethoxynaphthalene, 1,4-diethoxynaphthalene, 1,4-dibenzyloxynaphthalene, 1,2-diphenoxyethane, 1,2-bis(3-methylphenoxy)ethane, 1,2-bis(4-methylphenoxy)ethane, 1,4-diphenoxy-2-butene, 1,2-bis(4-methoxyphenylthio)ethane, dibenzoylmethane, 1,4-diphenylthiobutane, 1,4-diphenylthio-2-butene, 1,3-bis(2-vinyloxyethoxy)benzene, 1,4-bis(2-vinyloxyethoxy)benzene, p-(2-vinyloxyethoxy)biphenyl, p-aryloxybiphenyl, p-propargyloxybiphenyl, dibenzoyloxymethane, dibenzoyloxypropane, dibenzyl disulfide, 1,1-diphenyl ethanol, 1,1-diphenylpropanol, p-benzyloxy benzylalcohol, 1,3-phenoxy-2-propanol, N-octadecylcarbamoyl-p-methoxycarbonyl benzene, N-octadecylcarbamoyl benzene, 1,2-bis(4-methoxyphenoxy)propane, 1,5-bis(4-methoxyphenoxy)-3-oxapentane, dibenzyl oxalate, bis(4-methylbenzyl) oxalate, and bis(4-chlorobenzyl) oxalate. Above-listed examples may be used alone or in combination.

### -Lubricant-

Examples of the lubricant include higher fatty acids or metal salts of higher fatty acids, higher fatty acid amides, higher fatty acid esters, animal wax, vegetable wax, mineral wax, petroleum wax, and synthetic wax. Above-listed examples may be used alone or in combination.

### -Filler-

Examples of the filler include: inorganic powder such as calcium carbonate, silica, zinc oxide, titanium oxide, zirconium oxide, aluminum hydroxide, zinc hydroxide, barium sulfate, clay, kaolin, talc, surface-treated calcium, and surface-treated silica; and organic powder such as urea-formalin resins, styrene-methacrylic acid copolymers, polystyrene resins, and vinylidene chloride resins. Above-listed examples may be used alone or in combination.

An amount of the filler is not particularly limited and may be appropriately selected depending on the intended purpose. The amount of the filler is preferably 0.4 parts by mass or less, and more preferably 0.2 parts by mass or less, relative to 1 part by mass of the binder resin.

-Ultraviolet Absorber-

The ultraviolet absorber is not particularly limited and may be appropriately selected depending on the intended purpose. Examples of the ultraviolet absorber include a salicylic acid-based ultraviolet absorber, a benzophenone-based ultraviolet absorber, and a benzotriazole-based ultraviolet absorber.

Examples of the ultraviolet absorber include salicylate, p-tert-butylphenyl salicylate, p-octylphenyl salicylate, 2,4-dihydroxybenzophenone, 2-hydroxy-4-methoxybenzophenone, 2-hydroxy-4-octoxybenzophenone, 2-hydroxy-4-dodecyloxybenzophenone, 2,2′-dihydroxy-4-methoxybenzophenone, 2,2′-dihydroxy-4,4′-dimethoxybenzophenone, 2-hydroxy-4-methoxy-5-sulfobenzophenone, bis(2-methoxy-4-hydroxy-5-benzoylphenyl)methane, 2-(2′-hydroxy-5′-methylphenyl)benzotriazole, 2-(2′-hydroxy-5′-tert-butylphenyl)benzotriazole, 2-(2′-hydroxy-3′,5′-di-tert-butylphenyl)benzotriazole, 2-(2′-hydroxy-3′,5′-di-tert-butylphenyl)chlorobenzotriazole, 2-(2′-hydroxy-3′-tert-butyl-5′-methylphenyl)-5-chlorobenzotriazole, 2-(2′-hydroxy-3′,5′-di-tert-amylphenyl)benzotriazole, 2-{2′-hydroxy-3′-(3″,4″,5″,6″-tetrahydrophthalimidemethyl)-5′-methylphenyl}benzotriazole, 2,2′-methylenebis{4-(1,1,3,3-tetramethylbutyl)-6-(2H-benzotriazol-2-yl)phenol}, 2-(2′-hydroxy-5′-methacryloxyphenyl)-2H-benzotriazole, 2-(3,5-di-t-amyl-2-hydroxyphenyl)benzotriazole, 2-(2′-hydroxy-5′-t-octylphenyl)benzotriazole, and 2-(5-methyl-2-hydroxyphenyl)benzotriazole. The above-listed examples may be used alone or in combination.

### (Method for Producing Thermosensitive Recording Medium)

The method for producing a thermosensitive recording medium of the present disclosure include a thermosensitive recording layer forming step and may further include other steps according to the necessity. The thermosensitive recording layer forming step includes applying the thermosensitive recording forming liquid of the present disclosure onto a support to form a thermosensitive recording layer.

In the thermosensitive recording layer forming step, the thermosensitive recording layer forming liquid is preferably applied onto a partial region of the support.

In the present specification, the “partial region” of the support means a region that is part of the entire region of the support, and has an area less than 100% relative to the total area of the surface of the support. A shape, size, number, arrangement, etc. of the thermosensitive recording layer are not particularly limited and may be appropriately selected depending on the intended purpose.

The formation method of the thermosensitive recording layer is not particularly limited and may be appropriately selected depending on the intended purpose. For example, the electron-donating compound and the electron-accepting compound solubility of which to 100% ethanol at 20° C. is 5.0% by mass or less are pulverized and dispersed together with the above-mentioned other components by means of a disperser, such as a ball mill, attritor, and a sand mill in a manner that particle diameters of dispersed elements are to be 0.1 micrometers or greater but 3 micrometers or less, followed by mixing optionally together with the filler, to thereby prepare a thermosensitive recording layer forming liquid. The thermosensitive recording layer forming liquid is then applied onto a support, followed by drying, to thereby form a thermosensitive recording layer.

The application method is not particularly limited and may be appropriately selected depending on the intended purpose. Examples of the application method include blade coating, gravure coating, gravure offset coating, bar coating, roll coating, knife coating, air knife coating, comma coating, U-comma coating, AKKU coating, smoothing coating, microgravure coating, reverse roll coating, 4 or 5-roll coating, dip coating, curtain coating, slide coating, and die coating.

A deposition amount of the thermosensitive recording layer forming liquid after being dried is not particularly limited and may be appropriately selected depending on the intended purpose. The deposition amount thereof is preferably 1 g/m² or greater but 20 g/m² or less, and more preferably 2 g/m² or greater but 10 g/m² or less on dry basis.

### (Thermosensitive Recording Medium)

The thermosensitive recording medium of the present disclosure includes a support, and a thermosensitive recording layer formed on the support with the thermosensitive recording layer forming liquid of the present disclosure. The thermosensitive recording medium may further include other layers according to the necessity. In other words, the thermosensitive recording medium of the present disclosure includes a support, and a thermosensitive recording layer formed on the support, where the thermosensitive recording layer includes an electron-donating compound and an electron-accepting compound, and solubility of the electron-accepting compound to 100% ethanol at 20° C. is 5% by mass or less. The thermosensitive recording medium may further include other layers according to the necessity.

Moreover, the thermosensitive recording medium of the present disclosure preferably includes a support, and a thermosensitive recording layer formed of the thermosensitive recording layer forming liquid of the present disclosure on a partial region of the support.

In the present specification, the “partial region” of the support means a region that is part of the entire region of the support, and means that the thermosensitive recording layer has an area less than 100% relative to the total area of the surface of the support. A shape, size, number, arrangement, etc. of the thermosensitive recording layer are not particularly limited and may be appropriately selected depending on the intended purpose.

The thermosensitive recording medium of the present disclosure includes a support, and a thermosensitive recording layer disposed on or above the support, where the thermosensitive recording layer includes an electron-donating compound and an electron-accepting compound, and solubility of the electron-accepting compound to 100% ethanol at 20° C. is 5.0% by mass or less. A variation in thickness of the thermosensitive layer in the region excluding the edge of the thermosensitive recording layer, which is represented by the following formula, is 50% or less. The thermosensitive recording medium may further include other layers according to the necessity.

Moreover, the thermosensitive recording medium of the present disclosure preferably includes a support, and a thermosensitive recording layer disposed on a partial region of the support, where the thermosensitive recording layer includes an electron-accepting compound solubility of which to 100% ethanol at 20° C. is 5.0% by mass or less.

In the present specification, the “partial region” of the support means a region that is part of the entire region of the support, and means that the thermosensitive recording layer has an area less than 100% relative to the total area of the surface of the support. A shape, size, number, arrangement, etc. of the thermosensitive recording layer are not particularly limited and may be appropriately selected depending on the intended purpose.

The average thickness of the thermosensitive recording layer is not particularly limited and may be appropriately selected depending on the intended purpose. The average thickness of the thermosensitive recording layer is preferably 1 micrometer or greater but 20 micrometers or less, and more preferably 2 micrometers or greater but 10 micrometers or less.

The variation in the thickness of the thermosensitive recording layer in the region excluding the edge of the thermosensitive recording layer, which is represented by the following formula, is 50% or less, preferably 30% or less, more preferably 20% or less, and even more preferably 10% or less.

Variation in thickness of thermosensitive recording layer (%)=[(the maximum thickness of the thermosensitive recording layer or the minimum thickness of the thermosensitive recording layer− an average thickness of the thermosensitive recording layer)/the average thickness of the thermosensitive recording layer]×100 The maximum thickness of the thermosensitive recording layer is a maximum value of the thickness of the thermosensitive recording layer, and the minimum thickness of the thermosensitive recording layer is a minimum value of the thickness of the thermosensitive recording layer, when the thickness of the thermosensitive recording layer is measured at arbitrary 20 points on the thermosensitive recording medium, and the average thickness of the thermosensitive recording layer is an average value of values measured at 18 points excluding the maximum thickness of the thermosensitive recording layer and the minimum thickness of the thermosensitive recording layer among the 20 points, the larger value between an absolute value of (the maximum thickness of the thermosensitive recording layer—the average thickness of the thermosensitive recording layer) and an absolute value of (the minimum thickness of the thermosensitive recording layer—the average thickness of the thermosensitive recording layer) is selected.

For example, the thickness of the thermosensitive recording layer can be measured by a film thickness gauge. The film thickness can be also measured from a cross-sectional photograph of the thermosensitive recording medium obtained by an electron microscope. Any measuring method can be used as long as the thickness of the thermosensitive recording layer can be measured, and the measuring method is not particularly limited.

As the film thickness gauge, for example, K-402B STAND and an electron micrometer K351C, available from ANRITSU CORPORATION may be used.

A thickness of the thermosensitive recording layer in the thermosensitive recording medium, in which other layers (the protective layer, the printed payer, etc.) in addition to the thermosensitive recording layer are formed on the support can be measured by any of the following methods.
(1) A single layer is printed on a support under the set conditions, followed by drying. After drying, the thickness of the film is measured by a film thickness gauge. Since the conditions are identical even when layers are laminated, the measured amount of the single layer can be used as the thickness of the layer when the layer is laminated.
(2) A thickness of a first layer on a support is measured by a film thickness gauge, and a thickness of a second layer can be determined by measuring a total thickness by the film thickness gauge and subtracting the thickness of the first layer from the total thickness.
(3) A thermosensitive recording medium is cut by Cross section Polisher SM0920CP (available from JEOL Ltd.) to expose an cross-section thereof, and the cross-section is observed under a scanning electron microscope (SEM) S-3700 (available from Hitachi High-Tech Corporation) to measure a thickness of each layer.

The less variation in the thickness of the thermosensitive recording layer is more preferable. When the variation in the thickness is significant, such variation can be visually recognized in a non-colored state, but the variation particularly appears as the density variation in the colored state. When the variation in the thickness is greater than 50% relative to the average value of the thickness within the partial region to which the thermosensitive recording layer is disposed, the variation in the thickness appears as the density variation in the uncolored or colored area, and therefore it is not visually preferable when various patterns, such as lines, letters, shapes, designs, bar codes, and solid images, are printed.

When the variation in the thickness is 30% or greater but 50% or less, the variation cannot be recognized in the uncolored area, but the density unevenness can be recognized in the colored area.

When the variation in the thickness is greater than 10% but less than 30%, moreover, the variation is slightly recognized as the density unevenness in the colored area, which only affects limited patterns, such as a solid printing over a large area.

When the variation in the thickness is 10% or less, furthermore, the variation cannot be easily visually recognized in the uncolored area and the colored area, and therefore any design can be used without causing any defect in coloring.

### <Support>

A shape, structure, size, material, etc. of the support are not particularly limited and may be appropriately selected depending on the intended purpose. Examples of the shape of the support include a flat plate, and a sheet. The structure of the support may be a single-layer structure, or a multiple-layer structure. The size of the support may be appropriately selected depending on the size etc. of the thermosensitive recording medium.

As the support, for example, as well as typical paper, synthesis paper, or a plastic film, such as polyethylene, transparent polyethylene terephthalate, polypropylene, and vinyl chloride, may be used. When a plastic film is used as the support, a surface treatment, such as a matte finish treatment, and a corona treatment, may be performed on the support to improve fixability of a coating liquid. Among the above-listed examples, a polyethylene terephthalate sheet formed by biaxial stretching is preferable because of excellent strength, heat resistance, and size stability thereof. Moreover, a white opaque film formed by adding a white raw material or filler to the film, or a foam sheet formed by foaming may be used. Furthermore, a laminate of the above-listed materials may be also used. Typical examples thereof include a laminate of cellulose fiber filaments and synthesis paper, a laminate of cellulose fiber filaments and a plastic film, and a laminate of a plastic film and synthesis paper. The support is preferably a transparent film for use in the field of the POS system for fresh food, packed meals, and pre-made meals, because the contents can visually recognized. In the present disclosure, the transparency is not particularly limited as long as a haze degree (turbidity) that is an index for indicating transparency of a film is about 10% or less. In order to achieve the object of the present disclosure, the haze degree of the support is more preferably 5% or less.

The average thickness of the support may be appropriately adjusted depending on the necessity. Considering transparency or processability, the average thickness of the support is preferably 3 micrometers or greater but 300 micrometers or less. When the average thickness of the support is less than 3 micrometers, the strength of the support may be insufficient. When the average thickness of the support is greater than 300 micrometers, transparency of the support may reduce, and processability reduces because rigidity of the support is too high.

### <Protective Layer>

The protective layer includes a binder resin, and a crosslinking agent, and may further include other components according to the necessity. The protective layer is preferably disposed on the thermosensitive recording layer.

The binder resin is not particularly limited and may be appropriately selected depending on the intended purpose. In case of partial coating, a binder resin usable in the thermosensitive recording layer may be selected as the binder resin of the protective layer.

Examples of the binder resin include: acryl resins; polyvinyl alcohol resins; starch or derivatives of starch; cellulose derivatives such as hydroxymethyl cellulose, hydroxyethyl cellulose, carboxymethyl cellulose, methyl cellulose, and ethyl cellulose; water-soluble polymers such as sodium polyacrylate, polyvinyl pyrrolidone, acrylamide-acrylic acid ester copolymers, styrene-acryl copolymers, acrylamide-acrylic acid ester-methacrylic acid terpolymers, styrene-maleic anhydride copolymer alkali salts, isobutylene-maleic anhydride copolymer alkali salts, polyacrylamide, sodium alginate, gelatin, and casein; emulsions of, for example, polyvinyl acetate, polyurethane, polyacrylic acid, polyacrylic acid ester, vinyl chloride-vinyl acetate copolymers, polybutyl methacrylate, and ethylene-vinyl acetate copolymers; and latexes of, for example, styrene-butadiene copolymers and styrene-butadiene-acrylic copolymers. Above-listed examples may be used alone or in combination. Among the above-listed examples, an acryl resin and a styrene-acryl copolymer are preferable when the protective layer is desired to have transparency.

When the protective layer is applied onto the entire surface, a water-soluble resin may be used as the binder.

Examples of the water-soluble resin include, polyvinyl alcohol, modified polyvinyl alcohol, starch or derivatives of starch, cellulose derivatives (e.g., methoxy cellulose, hydroxyethyl cellulose, carboxymethyl cellulose, methyl cellulose, and ethyl cellulose), sodium polyacrylate, polyvinyl pyrrolidone, acrylamide-acrylic acid ester copolymers, acrylamide-acrylic acid ester-methacrylic acid terpolymers, styrene-maleic anhydride copolymer alkali salts, isobutylene-maleic anhydride copolymer alkali salts, polyacrylamide, modified polyacryl amide, methyl vinyl ether-maleic anhydride copolymers, carboxy-modified polyethylene, polyvinyl alcohol-acrylamide block copolymers, melamine-formaldehyde resins, urea-formamide resins, sodium alginate, gelatin, and casein. Above-listed examples may be used alone or in combination. Among the above-listed examples, modified polyvinyl alcohol is preferable. Examples of the modified polyvinyl alcohol include diacetone-modified polyvinyl alcohol, acetoacetyl-modified polyvinyl alcohol, and carboxylic acid-modified polyvinyl alcohol (e.g., itaconic acid-modified polyvinyl alcohol, and maleic acid-modified polyvinyl alcohol).

The crosslinking agent is appropriately selected depending on the intended purpose, such as heat resistance and matching with a thermal head. Examples of the crosslinking agent include a glyoxal derivative, a methylol derivative, epichlorohydrin, polyamide epichlorohydrin, an epoxy resin, an aziridine compound, hydrazine, a hydrazide derivative, an oxazoline derivative, and a carbodimide derivative. Above-listed examples may be used alone or in combination. Among the above-listed examples, an adiridine compound and carbodimide derivative having excellent water resistance and solvent resistance are preferable because the adiridine compound and carbodimide derivative have high reactivity with a carboxyl group of an acryl resin to form a crosslink structure.

An amount of the crosslinking agent is not particularly limited and may be appropriately selected depending on the intended purpose. The amount of the crosslinking agent is preferably 10 parts by mass or greater but 60 parts by mass or less, and more preferably 20 parts by mass or greater but 50 parts by mass or less, relative to 100 parts by mass of the binder resin.

Moreover, a pigment (filler) is preferably optionally added to the protective layer. Examples of the pigment used in the protective layer include: inorganic pigments, such as zinc oxide, calcium carbonate, barium sulfate, titanium oxide, lithopone, talc, agal-matolite, kaolin, aluminium hydroxide, and calcined kaolin; and organic pigments, such as crosslinked polystyrene resins, urea resins, silicone resins, crosslinked polymethyl methacrylate resins, and melamine-formaldehyde resins.

In addition to the above-listed resin, crosslinking agent, and pigment, the protective layer may include auxiliary additive components known in the art in combination, such as a surfactant, a thermofusible material, a lubricant, a pressure-coloring inhibitor.

The protective layer is not particularly limited and may be formed according to any of methods known in the art.

The average thickness of the protective layer is not particularly limited and may be appropriately selected depending on the intended purpose. The average thickness of the protective layer is preferably 0.5 micrometers or greater but 5 micrometers or less, and more preferably 1 micrometer or greater but 3 micrometers or less.

### <Printed Layer>

The printed layer is formed in any of various colors, is formed of any of various materials, and is formed with any thickness. The printed layer constitute a background of the image printed on the thermosensitive recording layer. A product name, a name of a manufacturer, ingredient labeling etc. can be marked before packaging a product by disposing the printed layer. Moreover, the printed layer can provide excellent design to a product. Since the thermosensitive recording layer of the present disclosure can be partially printed, the printed layer can be formed at the same time as the formation of the thermosensitive recording layer.

The printed layer is preferably disposed at at least one location selected from the group consisting of on or above the thermosensitive recording layer, between the support and the thermosensitive recording layer, and on or above an opposite surface of the support to the surface thereof on which the thermosensitive recording layer is disposed. When an object is wrapped with the thermosensitive recording medium serving as a wrapping sheet, the object can be easily visible through the area of the thermosensitive recording medium where the printed layer is not disposed.

The printed layer includes a colorant, a binder resin, and a solvent, and may further include other components according to the necessity.

The colorant is not particularly limited and may be appropriately selected depending on the intended purpose. As the colorant, a pigment or a dye may be used.

As the binder resin and other components, those used in the thermosensitive recording layer may be used.

The printed layer may be formed by gravure printing, flexographic printing, offset printing, UV printing, or inkjet printing.

The average thickness of the printed layer is not particularly limited and may be appropriately selected depending on the intended purpose. The average thickness of the printed layer is preferably 0.05 micrometers or greater but 4 micrometers or less, and more preferably 0.1 micrometers or greater but 2 micrometers or less.

### <Other Layers>

The above-mentioned other layers are not particularly limited and may be appropriately selected depending on the intended purpose. Examples thereof include a back layer, an under layer, a heat seal layer, a release layer, and an adhesive layer.

### -Back Layer-

A back layer may be disposed for preventing curling of the thermosensitive recording medium. When transparency of the thermosensitive recording medium is important, the back layer is preferably not disposed.

When the back layer is disposed, the back layer is optionally disposed on a surface of the support at the side of which the thermosensitive recording layer is not disposed.

The back layer includes filler, and a binder resin, and may further include other components, such as a lubricant, and a color pigment.

As the filler, for example, inorganic filler or organic filler may be used.

Examples of the inorganic filler include carbonates, silicates, metal oxides, and sulfuric acid compounds.

Examples of the organic filler include silicone resins, cellulose, epoxy resins, nylon resins, phenol resins, polyurethane resins, urea resins, melamine resins, polyester resins, polycarbonate resins, styrene resins, acryl resins, polyethylene resins, formaldehyde resins, and polymethyl methacrylate resins.

The binder resin is not particularly limited and may be appropriately selected depending on the intended purpose. For example, the binder resin usable in the thermosensitive recording layer can be used as the binder resin of the back layer.

The average thickness of the back layer is not particularly limited and may be appropriately selected depending on the intended purpose. The average thickness of the back layer is preferably 0.1 micrometers or greater but 20 micrometers or less, and more preferably 0.3 micrometers or greater but 10 micrometers or less.

### -Under Layer-

The under layer may be disposed for the purpose of improving coloring sensitivity of the thermosensitive recording medium. When transparency of the thermosensitive recording medium is important, the under layer is preferably not disposed.

When the under layer is disposed, the under layer is not particularly limited and may be appropriately selected depending on the intended purpose. The under layer includes an adhesive resin, and hollow thermoplastic resin particles. The under layer may further include other components according to the necessity.

The hollow thermoplastic resin particles are micro hollow particles in the state of a foam. Each hollow thermoplastic resin particle includes a shell of a thermoplastic resin, and air or another gas inside the shell.

The average particle diameter (particle outer diameter) of the hollow thermoplastic resin particles is not particularly limited and may be appropriately selected depending on the intended purpose. The average particle diameter of the hollow thermoplastic resin particles is preferably 0.2 micrometers or greater but 20 micrometers or less, and more preferably 2 micrometers or greater but 5 micrometers or less. When the average particle diameter is less than 0.2 micrometers, it is technically difficult to make the particles hollow, and therefore a function as the undercoat layer cannot be exhibited sufficiently. When the average particle diameter is greater than 20 micrometers, smoothness of the surface of the under layer after coating and drying reduces, which leads an uneven coating of a thermosensitive recording layer, and therefore more than a required amount of the thermosensitive recording layer coating liquid is applied to make the coating even.

Accordingly, the hollow thermoplastic resin particles preferably have the above-mentioned range of the number average particle diameter, and have a uniform distribution peak without unevenness.

The void ratio of the hollow thermoplastic resin particles is not particularly limited and may be appropriately selected depending on the intended purpose. The void ratio of the hollow thermoplastic resin particles is preferably from 50% through 95%, and more preferably from 80% through 95%.

When the void ratio is less than 30%, thermal insulation of the under layer is insufficient, and therefore thermal energy applied from a thermal head is released outside of the thermosensitive recording medium via the support, leading to an insufficient effect of improving sensitivity. The void ratio is a ratio between an outer diameter and inner diameter (diameter of a void) of a hollow particle, and is represented by the following formula.

Void ratio (%)=(inner diameter of hollow particle/outer diameter of hollow particle)×100

As described above, each of the hollow thermoplastic resin particles includes a shell of a thermoplastic resin. The thermoplastic resin is not particularly limited and may be appropriately selected depending on the intended purpose. Examples of the thermoplastic resin include styrene-acryl resins, polystyrene resins, acryl resins, polyethylene resins, polypropylene resins, polyacetal resins, chlorinated polyether resins, polyvinyl chloride resins, and a copolymer resin including vinylidene chloride and acrylonitrile as main components. Among the above-listed examples, a styreneacryl resin, and a copolymer resin including vinylidene chloride and acrylonitrile as main components are preferable because a void ratio can be made high, variation in particle diameters can be minimized, and blade coating can be suitably applied at the time of coating.

An applied amount of the hollow plastic particles is not particularly limited and may be appropriately selected depending on the intended purpose. In order to maintain sensitivity and uniformity of coating, the amount thereof is ideally from 1 g through 3 g per 1 m² of the support. When the amount thereof is less than 1 g/m², sufficient sensitivity cannot be obtained. When the amount thereof is greater than 3 g/m², cohesion of the under layer decreases.

### -Heat Seal Layer-

The heat seal layer is formed by laminating films of low density polyethylene (LDPE) used as a sealant. Therefore, the heat seal layer can be fused by heating in the state where the heat seal films are closely in contact with one another. Using the above-mentioned characteristics, a packaging sheet formed onto a bag is heated in the above-described state to seal, i.e., heat seal. Accordingly, a material for forming the heat seal layer is not limited to LDPE as long as the material is a material that is heat sealable, i.e., a heat seal material.

As the heat seal material, for example, films of high density polyethylene (HDPE), cast polypropylene (CPP), oriented polypropylene (OPP), and ethylene-vinyl acetate copolymer (EVA) etc., are suitably used. Moreover, a polyolefin resin (e.g., polyethylene, and polypropylene), a vinyl acetate-based resin (e.g., an olefin-vinyl acetate copolymer, such as an ethylene-vinyl acetate copolymer), or an acrylic resin (e.g., an olefin-(meth)acrylic acid copolymer, such as an ethylene-(meth)acrylic acid copolymer and iomer, and metal crosslinked products thereof) may be used. Furthermore, any of known heat seal adhesives may be used. In order to make a packaged product visible, a member that becomes transparent after forming is preferably used.

The average thickness of the heat seal layer is preferably 5 micrometers or greater but 50 micrometers or less, and more preferably 10 micrometers or greater but 30 micrometers or less, considering transparency and sealing strength.

### -Release Layer-

The release layer include a releasing agent. Examples of the releasing agent include UV-curable silicone, heat-curable silicone, solvent-free silicone, solvent-based silicone, emulsion silicone, and a fluorine-based releasing agent.

### -Adhesive Layer-

A main component of an adhesive included in the adhesive layer is preferably at least one selected from the group consisting of an acrylic resin obtained through emulsification polymerization of monomers including at least one of (meth)acrylic acid alkyl ester having an alkyl group as a main component, an acrylic acid ester-styrene copolymer, and an acrylic acid ester-methacrylic acid ester-styrene copolymer.

The term “main component” means that the component excludes optionally blended additives, such as a penetrating agent, a film formation auxiliary agent, a defoaming agent, an antirust agent, a thickener, a wetting agent, an antiseptic agent, an UV absorber, a photostabilizer, a pigment, and inorganic filler, and is formed of a resin. In the present disclosure, the term “(meth)acryl” means “acryl or methacryl.”

Specific examples of (meth)acrylic acid alkyl ester include n-pentyl(meth)acrylate, n-hexyl(meth)acrylate, 2-ethylhexyl(meth)acrylate, n-octyl(meth)acrylate, isooctyl(meth)acrylate, n-decyl (meth)acrylate, and n-dodecyl(meth)acrylate. The above-listed examples may be used alone or in combination.

In addition to the components above, carboxyl group-containing radical polymerizable unsaturated monomers, (meth)acrylic acid alkyl ester, or radical polymerizable unsaturated monomers copolymerizable with each unsaturated monomer of the carboxyl group-containing radical polymerizable unsaturated monomers may be optionally added.

Examples of a carboxyl group-containing radical polymerizable unsaturated monomer include α,β-unsaturated carboxylic acid (e.g., (meth)acrylic acid), and α,β-unsaturated dicarboxylic acid (e.g., itaconic acid, maleic acid, and 2-methyleneglutaric acid). The above-listed examples may be used alone or in combination.

A deposition amount of the adhesive layer on dry basis is preferably from 8 g/m² through 30 g/m², and more preferably from 12 g/m² through 25 g/m². When the deposition amount thereof on dry basis is less than 8 g/m², sufficient adhesion force may not be obtained.

A coating method of an adhesive layer forming liquid is not particularly limited and may be appropriately selected depending on the intended purpose. Examples thereof include: a coating method, such as roll coating, knife coating, bar coating, slot die coating, and curtain coating; and a printing method, such as gravure printing, and flexographic printing.

The adhesive layer may be formed by directly applying the adhesive layer coating liquid onto a surface of the support opposite to the surface thereof where a release layer is formed, and drying the adhesive layer coating liquid. Alternatively, an adhesive layer forming liquid is applied onto a base having releasability, followed by drying, and the adhesive layer is transferred onto a surface of a support on which a release layer is not disposed, and only the base is removed, to thereby form the adhesive layer.

An embodiment of the thermosensitive recording medium of the present disclosure is not particularly limited, and may be appropriately selected depending on the intended purpose. For example, the thermosensitive recording medium may be used as a label as it is, or a layer to which two-dimensional information, such as letters, marks, images, barcodes, and QR codes (registered trademark), is printed may be disposed on or above the protective layer or the support. Moreover, a release layer may be disposed at the same side of the support to which the thermosensitive recording layer is disposed, and an adhesive layer may be disposed at the opposite side of the support to the side of the support where the thermosensitive recording layer is disposed.

Moreover, a shape of the thermosensitive recording medium of the present disclosure is not particularly limited and may be appropriately selected depending on the intended purpose. Examples thereof include labels, sheets, and rolls.

### <Use>

The thermosensitive recording medium of the present disclosure can be used in various fields. For example, the thermosensitive recording medium is used as a packaging film for various containers, such as PET bottles of soft drinks, metal cans of coffee, and bottles of energy drinks and medical products, and bottles of beer, or packaging labels in the field of the POS system for fresh food, packed meals, and pre-made meals.

### (Formation Method of Layers)

The thermosensitive recording layer, the over layer, and the printed layer can be formed by a printing system typically known in the art. The printed layer is a layer structure that is not necessary for the present disclosure, but information such as a product name, a manufacturer's name, ingredients, etc. can be recorded before packaging a product by disposing the printed layer, and the printed layer can impart excellent design to the product. Moreover, the thermosensitive recording layer (thermosensitive coloring layer) of the present disclosure can be partially printed, and therefore, the printed layer and the thermosensitive recording layer can be formed at the same time.

Moreover, the printed layer is disposed between the support and the thermosensitive recording layer, or at part of the back surface of the support. When a product is packaged with the thermosensitive recording medium serving as a wrapping sheet, the product can be visually observed through the area of the thermosensitive recording medium to which the printed layer is not disposed.

The printing system is not particularly limited, and any of printing systems known in the art can be used. Among the above-mentioned printing systems, a gravure printing system, and a flexographic printing system are preferable. Generally, the gravure printing system and the flexographic printing system are often used for a paper base or film base for packaging. Since various printing colors are used in the gravure printing system and the flexographic printing system, a device including printing heads for from 5 colors through 12 colors per step is generally used. For example, therefore, printing heads for a few color printing inks are used for design printing, and a thermosensitive recording layer and a protective layer can be printed at the same time by one-pass printing using the rest of the printing heads. Therefore, the better design position precision can be obtained compared with a production method of 2 passes or more, and the productivity can be significantly improved.

Selection of the printing system can be efficiently considered by combining the studies of laboratory scale, pilot scale, and actual device scale. At the laboratory scale, for example, an evaluation can be performed by means of a printer for laboratories (PRINTABILITY TESTER available from IGT, FLEXIPROOF available from Matsuo Sangyo Co., Ltd.). The evaluation device is not limited to the above-listed examples, and evaluation can be performed by means of any of commercially available general printers for laboratories. At the pilot scale and actual device scale, various gravure rolls and flexographic plates are produced according to a design and deposition amount corresponding to an evaluation, and as a result, practical evaluations can be performed.

Embodiments of the thermosensitive recording medium of the present disclosure will be described with reference to drawings. In the figures, the same numerical reference is given to the same constitutional component, and duplicated description may be omitted. Moreover, the number of the constitutional components to be disposed, the position where the constitutional component is disposed, and the shape of the constitutional component are not limited to the following embodiments, and any number, position, shape, etc. suitable for carrying out the present disclosure may be selected.

### First Embodiment

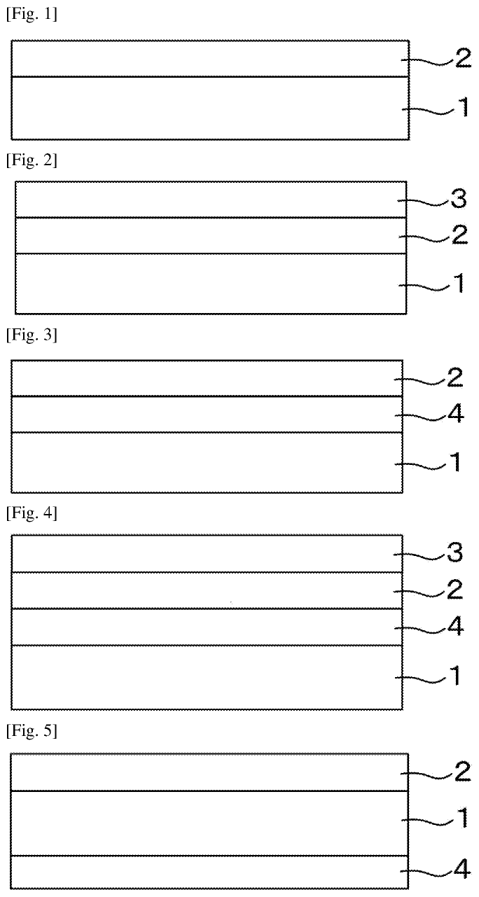

FIG. 1 is a schematic cross-sectional view illustrating an example of the thermosensitive recording medium of the first embodiment. The thermosensitive recording medium of the first embodiment includes a support 1, and a thermosensitive recording layer 2 disposed on the support 1.

### Second Embodiment

FIG. 2 is a schematic cross-sectional view illustrating an example of the thermosensitive recording medium of the second embodiment. The thermosensitive recording medium of the second embodiment includes a support 1, and a thermosensitive recording layer 2 and a protective layer 3 disposed on the support 1 in this order.

### Third Embodiment

FIG. 3 is a schematic cross-sectional view illustrating an example of the thermosensitive recording medium according to the third embodiment. The thermosensitive recording medium of the third embodiment includes a support 1, and a printed layer 4 and a thermosensitive recording layer 2 disposed on the support 1 in this order.

### Fourth Embodiment

FIG. 4 is a schematic cross-sectional view illustrating an example of the thermosensitive recording medium of the fourth embodiment. The thermosensitive recording medium of the fourth embodiment includes a support 1, and a printed layer 4, a thermosensitive recording layer 2, and a protective layer 3 disposed on the support 1 in this order.

### Fifth Embodiment

FIG. 5 is a schematic cross-sectional view illustrating an example of the thermosensitive recording medium of the fifth embodiment. The thermosensitive recording medium of the fifth embodiment includes a support 1, a thermosensitive recording layer 2 disposed on the support 1, and a printed layer 4 disposed on a surface of the support 1 at which the thermosensitive recording layer is not disposed.

### Sixth Embodiment

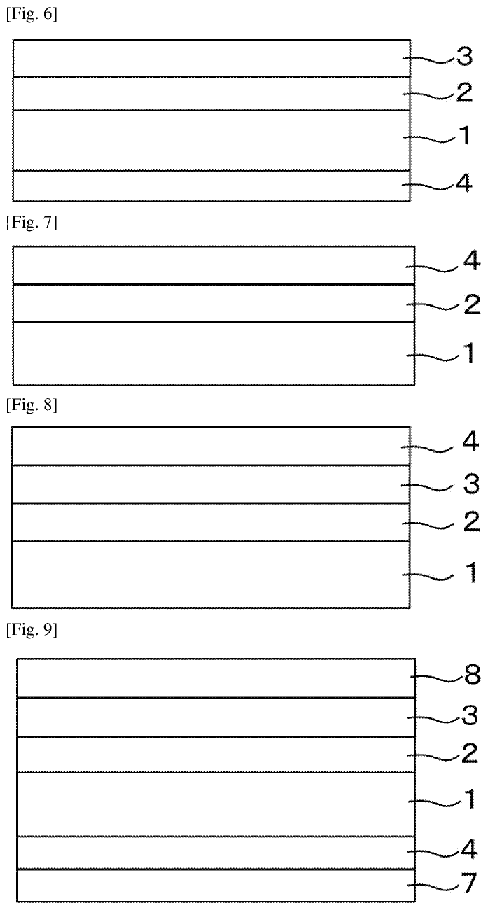

FIG. 6 is a schematic cross-sectional view illustrating an example of the thermosensitive recording medium of the sixth embodiment. The thermosensitive recording medium of the sixth embodiment includes a support 1, and a thermosensitive recording layer 2 and a protective layer 3 disposed on the support in this order, and a printed layer 4 disposed on a surface of the support 1 at which the thermosensitive recording layer is not disposed.

### Seventh Embodiment

FIG. 7 is a schematic cross-sectional view illustrating an example of the thermosensitive recording medium of the seventh embodiment. The thermosensitive recording medium of the seventh embodiment includes a support, and a thermosensitive recording layer 2 and a printed layer 4 disposed on the support 1 in this order.

### Eighth Embodiment

FIG. 8 is a schematic cross-sectional view illustrating an example of the thermosensitive recording medium of the eighth embodiment. The thermosensitive recording medium of the eighth embodiment includes a support 1, and a thermosensitive recording layer 2, a protective layer 3, and a printed layer 4 disposed on the support 1 in this order.

### Ninth Embodiment

FIG. 9 is a schematic cross-sectional view illustrating an example of the thermosensitive recording medium of the ninth embodiment. The thermosensitive recording medium of the ninth embodiment includes a support 1, and a thermosensitive recording layer 2, a protective layer 3, and a release layer 8 disposed on the support 1 in this order, and a printed layer 4 and an adhesive layer 7 disposed at the opposite side of the support 1, where the thermosensitive recording layer is not disposed, in this order.

### Tenth Embodiment

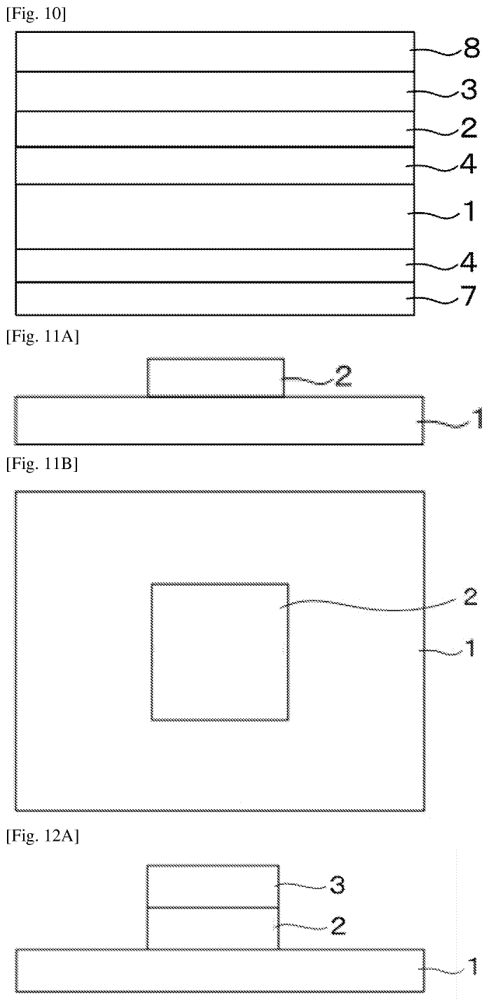

FIG. 10 is a schematic cross-sectional view illustrating an example of the thermosensitive recording medium of the tenth embodiment. The thermosensitive recording medium of the tenth embodiment includes a support 1, and a printed layer 4, a thermosensitive recording layer 2, a protective layer 3, and a release layer 8 disposed on the support 1 in this order, and a printed layer 4 and an adhesive layer 7 disposed at the opposite side of the support 1, where the thermosensitive recording layer is not disposed, in this order. In FIG. 10. The release layer is disposed at the outermost surface of the support at the same side as the side where the thermosensitive recording layer is disposed, and the adhesive layer is disposed at the outermost back surface of the support opposite to the side where the thermosensitive recording layer is disposed.

### Eleventh Embodiment

FIG. 11A is a schematic cross-sectional view illustrating an example of the thermosensitive recording medium of the eleventh embodiment. FIG. 11B is a schematic plan view (a surface of a support) illustrating the example of the thermosensitive recording medium of the eleventh embodiment.

The thermosensitive recording medium of the eleventh embodiment includes a support 1, and a thermosensitive recording layer 2 disposed on a partial region of the support 1. The phrase “the surface of the support” used here and hereinafter refers to a surface of the support at the side of which the thermosensitive recording layer is not disposed, unless otherwise stated.

### Twelfth Embodiment

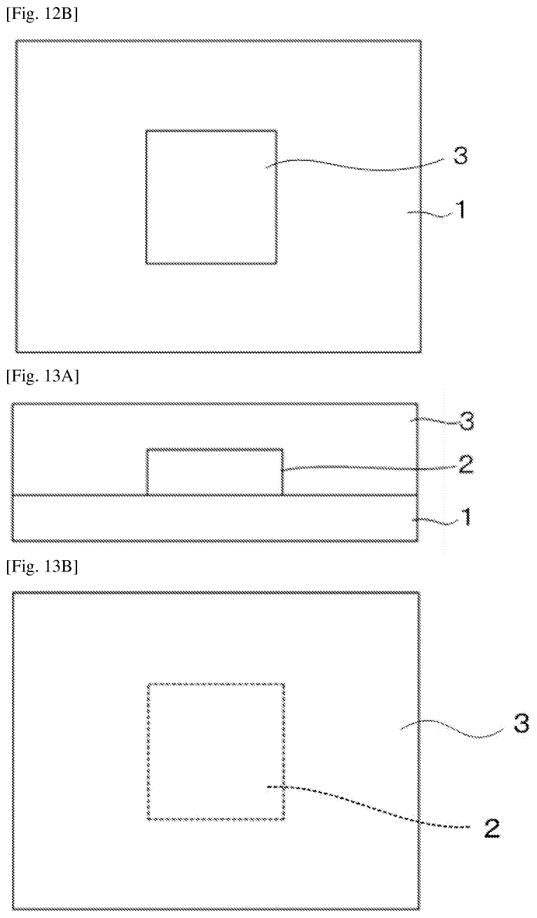

FIG. 12A is a schematic cross-sectional view illustrating an example of the thermosensitive recording medium of the twelfth embodiment. FIG. 12B is a schematic plan view (a surface of a support) illustrating the example of the thermosensitive recording medium of the twelfth embodiment.

The thermosensitive recording medium of the twelfth embodiment includes a support 1, and a thermosensitive recording layer 2 and a protective layer 3 on a partial region of the support 1 in this order.

### Thirteenth Embodiment

FIG. 13A is a schematic cross-sectional view illustrating an example of the thermosensitive recording medium of the thirteenth embodiment. FIG. 13B is a schematic plan view (a surface of a support) illustrating the example of the thermosensitive recording medium of the thirteenth embodiment.

The thermosensitive recording medium of the thirteenth embodiment includes a support 1, a thermosensitive recording layer 2 disposed on a partial region of the support 1, and a protective layer 3 on the entire surface of the support 1 at which the thermosensitive recording layer 2 is disposed.

### Fourteenth Embodiment

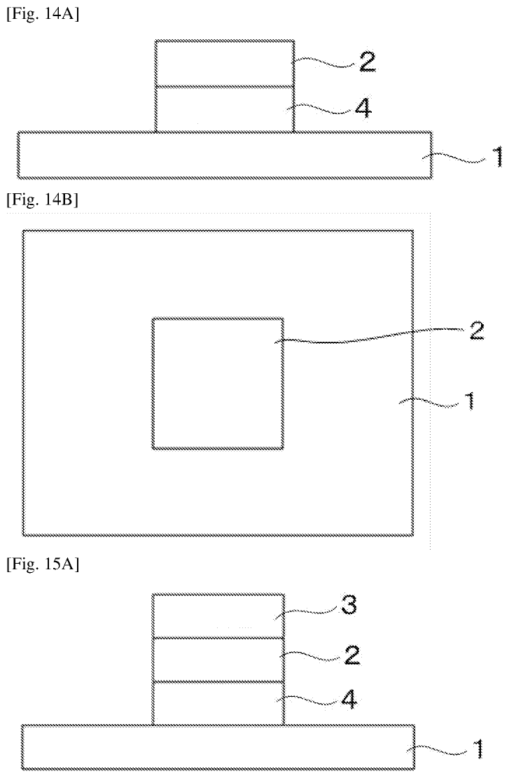

FIG. 14A is a schematic cross-sectional view illustrating an example of the thermosensitive recording medium of the fourteenth embodiment. FIG. 14B is a schematic plan view (a surface of a support) illustrating the example of the thermosensitive recording medium of the fourteenth embodiment.

The thermosensitive recording medium of the fourteenth embodiment includes a support 1, and a printed layer 4 and a thermosensitive recording layer 2 disposed on a partial region of the support 1 in this order.

### Fifteenth Embodiment

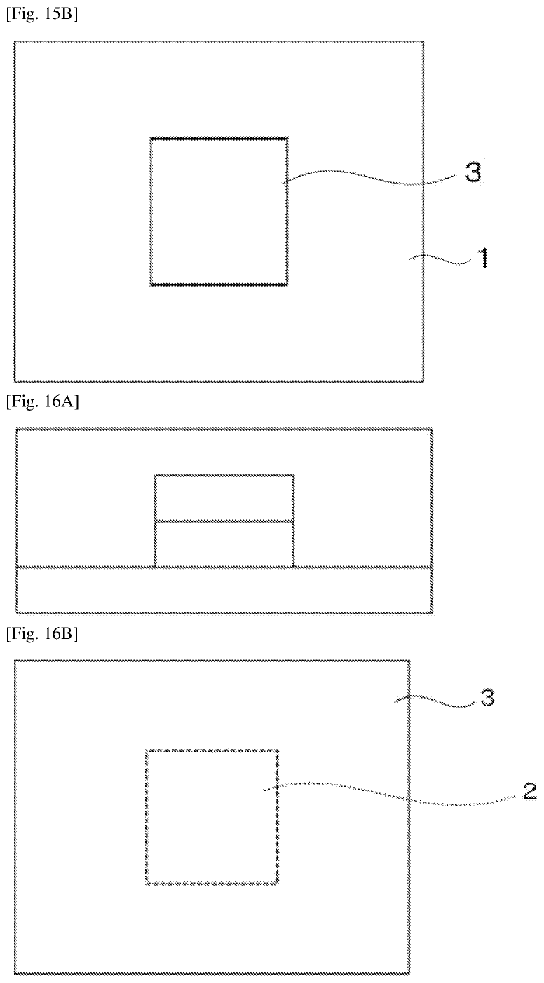

FIG. 15A is a schematic cross-sectional view illustrating an example of the thermosensitive recording medium of the fifteenth embodiment. FIG. 15B is a schematic plan view (a surface of a support) illustrating the example of the thermosensitive recording medium of the fifteenth embodiment.

The thermosensitive recording medium of the fifteenth embodiment includes a support 1, and a printed layer 4, a thermosensitive recording layer 2, and a protective layer 3 disposed on a partial region of the support 1 in this order.

### Sixteenth Embodiment

FIG. 16A is a schematic cross-sectional view illustrating an example of the thermosensitive recording medium of the sixteenth embodiment. FIG. 16B is a schematic plan view (a surface of a support) illustrating the example of the thermosensitive recording medium of the sixteenth embodiment.

The thermosensitive recording medium of the sixteenth embodiment is identical to the fourteenth embodiment, except that the protective layer 3 is disposed on the entire surface of the support 1 at the side of which the printed layer 4 and the thermosensitive recording layer 2 are disposed.

### Seventeenth Embodiment

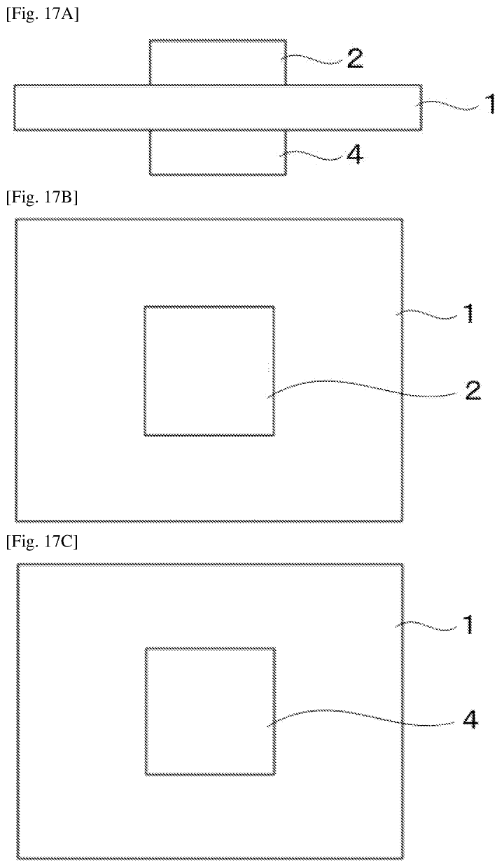

FIG. 17A is a schematic cross-sectional view illustrating an example of the thermosensitive recording medium of the seventeenth embodiment. FIG. 17B is a schematic plan view (a surface of a support) illustrating the example of the thermosensitive recording medium of the seventeenth embodiment. FIG. 17C is a schematic plan view (a back surface of the support) illustrating the example of the thermosensitive recording medium of the seventeenth embodiment. The phrase “a back surface of the support” used here and hereinafter refers to a surface of the support at the side of which the thermosensitive recording layer is disposed, unless otherwise stated.

The thermosensitive recording medium of the seventeenth embodiment is identical to the eleventh embodiment, except that a printed layer 4 is disposed on the back surface of the support 1.

### Eighteenth Embodiment

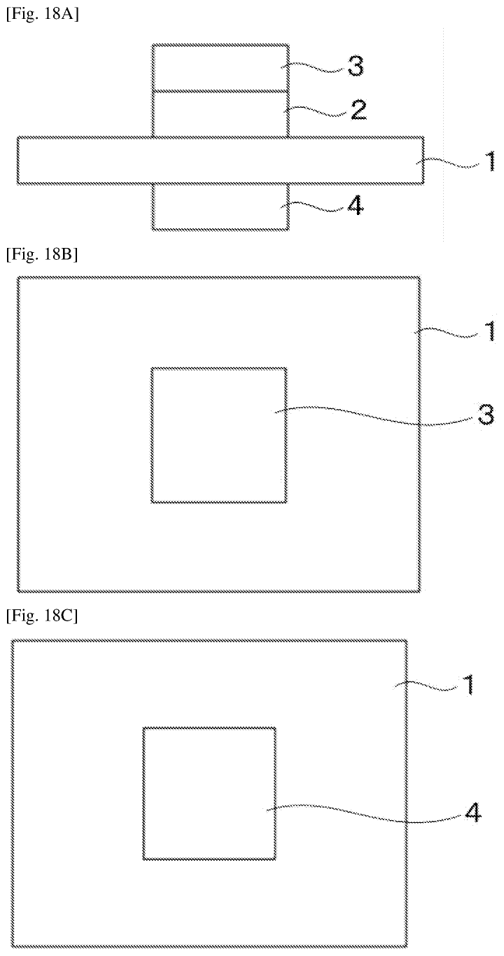

FIG. 18A is a schematic cross-sectional view illustrating an example of the thermosensitive recording medium of the eighteenth embodiment. FIG. 18B is a schematic plan view (a surface of a support) illustrating the example of the thermosensitive recording medium of the eighteenth embodiment. FIG. 18C is a schematic plan view (a back surface of the support) illustrating the example of the thermosensitive recording medium of the eighteenth embodiment.

The thermosensitive recording medium of the eighteenth embodiment is identical to the twelfth embodiment, except that a printed layer 4 is disposed on the back surface of the support 1.

### Nineteenth Embodiment

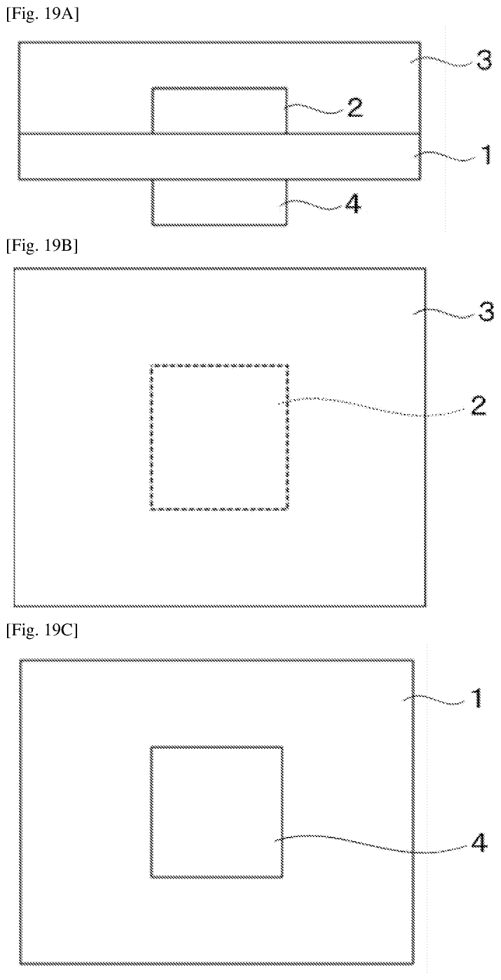

FIG. 19A is a schematic cross-sectional view illustrating an example of the thermosensitive recording medium of the nineteenth embodiment. FIG. 19B is a schematic plan view (a surface of a support) illustrating the example of the thermosensitive recording medium of the nineteenth embodiment. FIG. 19C is a schematic plan view (a back surface of the support) illustrating the example of the thermosensitive recording medium of the nineteenth embodiment.

The thermosensitive recording medium of the nineteenth embodiment is identical to the thirteenth embodiment, except that a printed layer 4 is disposed on the back surface of the support 1.

### Twentieth Embodiment

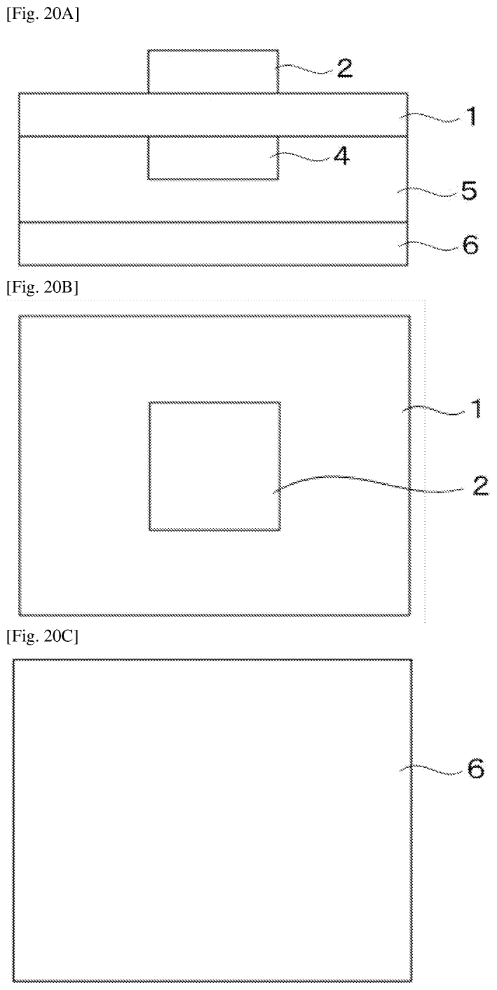

FIG. 20A is a schematic cross-sectional view illustrating an example of the thermosensitive recording medium of the twentieth embodiment. FIG. 20B is a schematic plan view (a surface of a support) illustrating the example of the thermosensitive recording medium of the twentieth embodiment. FIG. 20C is a schematic plan view (a back surface of the support) illustrating the example of the thermosensitive recording medium of the twentieth embodiment.

The thermosensitive recording medium of the twentieth embodiment is identical to the seventeenth embodiment, except that polyethylene (PE) 6 is laminated on the entire surface of the support 1, at the side of which the printed layer 4 is disposed, via a lamination adhesive 5.

### Twenty-First Embodiment

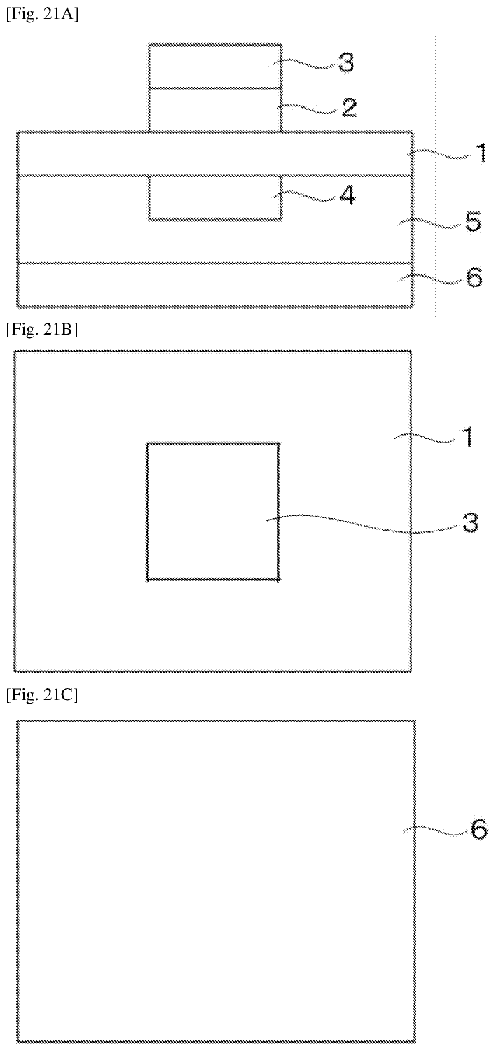

FIG. 21A is a schematic cross-sectional view illustrating an example of the thermosensitive recording medium of the twenty-first embodiment. FIG. 21B is a schematic plan view (a surface of a support) illustrating the example of the thermosensitive recording medium of the twenty-first embodiment. FIG. 21C is a schematic plan view (a back surface of the support) illustrating the example of the thermosensitive recording medium of the twenty-first embodiment.

The thermosensitive recording medium of the twenty-first embodiment is identical to the eighteenth embodiment, except that polyethylene (PE) 6 is laminated on the entire surface of the support 1, at the side of which the printed layer 4 is disposed, via a lamination adhesive 5.

### Twenty-Second Embodiment

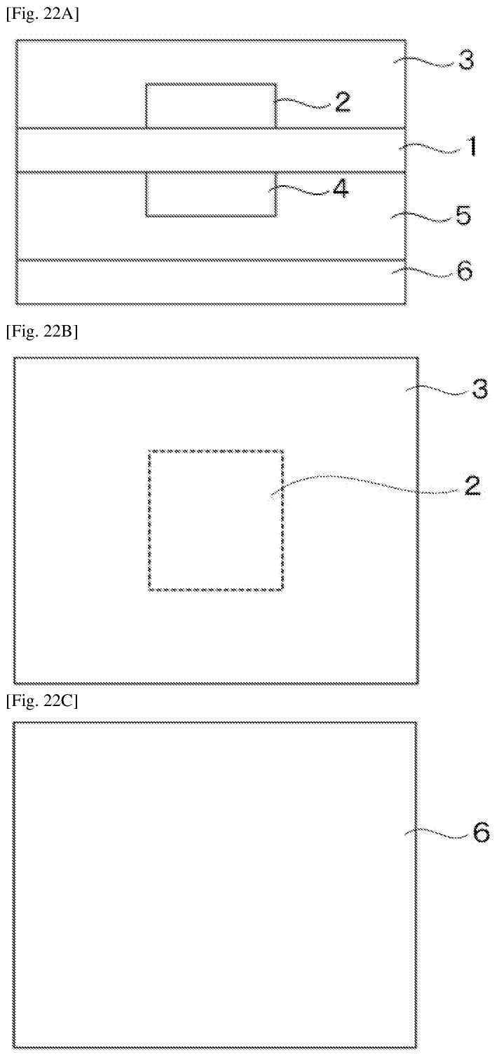

FIG. 22A is a schematic cross-sectional view illustrating an example of the thermosensitive recording medium of the twenty-second embodiment. FIG. 22B is a schematic plan view (a surface of a support) illustrating the example of the thermosensitive recording medium of the twenty-second embodiment. FIG. 22C is a schematic plan view (a back surface of the support) illustrating the example of the thermosensitive recording medium of the twenty-second embodiment.

The thermosensitive recording medium of the twenty-second embodiment is identical to the nineteenth embodiment, except that polyethylene (PE) 6 is laminated on the entire surface of the support 1, at the side of which the printed layer 4 is disposed, via a lamination adhesive 5.

### Twenty-Third Embodiment

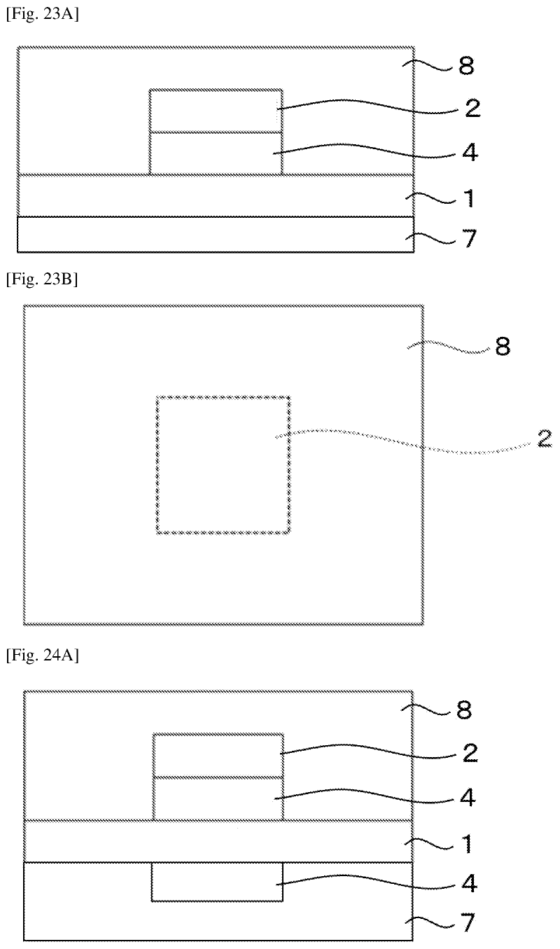

FIG. 23A is a schematic cross-sectional view illustrating an example of the thermosensitive recording medium of the twenty-third embodiment. FIG. 23B is a schematic plan view (a surface of a support) illustrating the example of the thermosensitive recording medium of the twenty-third embodiment.

The thermosensitive recording medium of the twenty-third embodiment includes a support, a printed layer 4 and a thermosensitive recording layer 2 disposed on a partial region of the support 1 in this order, a release layer 8 disposed the entire surface of the support covering the printed layer 4 and the thermosensitive recording layer 2, and an adhesive layer 7 disposed on an entire back surface of the support 1. The thermosensitive recording medium of the twenty-third embodiment may further include a protective layer.

### Twenty-Fourth Embodiment

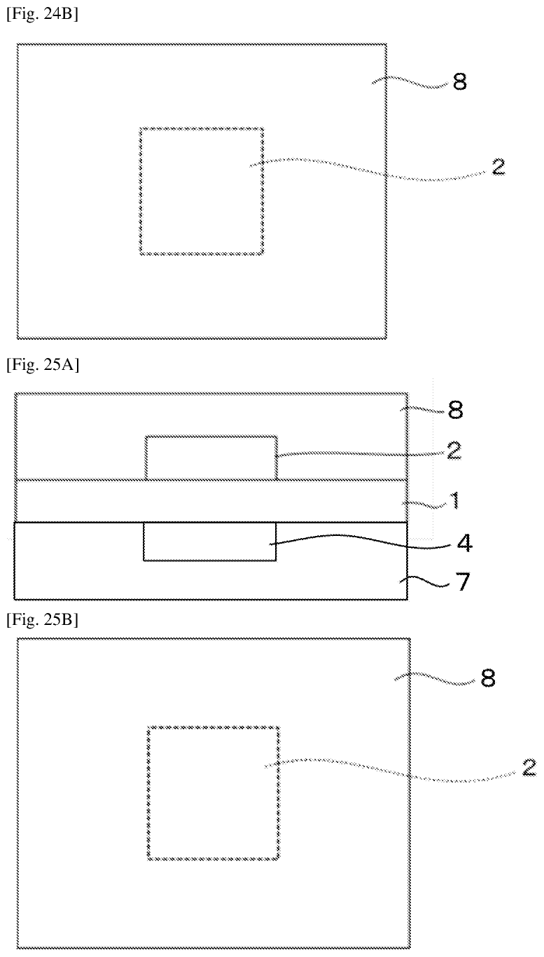

FIG. 24A is a schematic cross-sectional view illustrating an example of the thermosensitive recording medium of the twenty-fourth embodiment. FIG. 24B is a schematic plan view (a surface of a support) illustrating the example of the thermosensitive recording medium of the twenty-fourth embodiment.

The thermosensitive recording medium of the twenty-fourth embodiment includes a support 1, a printed layer 4 and a thermosensitive recording layer 2 disposed on a partial region of the support 1 in this order, a release layer 8 disposed on the entire surface of the support covering the printed layer 4 and the thermosensitive recording layer 2, a printed layer 4 disposed on a partial region of a back surface of the support 1, and an adhesive layer 7 disposed on the entire back surface of the support covering the printed layer 4. The thermosensitive recording medium of the twenty-fourth embodiment may further include a protective layer.

### Twenty-Fifth Embodiment

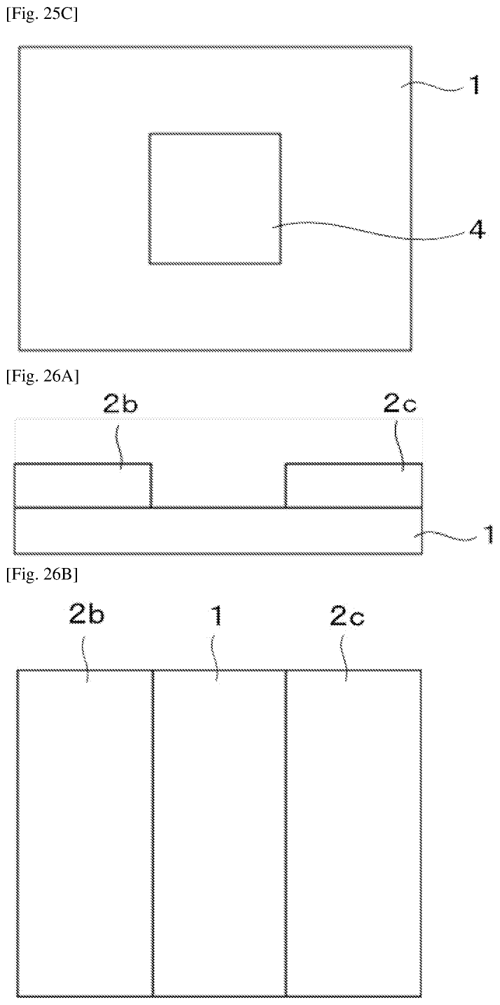

FIG. 25A is a schematic cross-sectional view illustrating an example of the thermosensitive recording medium of the twenty-fifth embodiment. FIG. 25B is a schematic plan view (a surface of a support) illustrating the example of the thermosensitive recording medium of the twenty-fifth embodiment. FIG. 25C is a schematic plan view (a back surface of the support) illustrating the example of the thermosensitive recording medium of the twenty-fifth embodiment.

The thermosensitive recording medium of the twenty-fifth embodiment includes a support 1, a thermosensitive recording layer 2 disposed on a partial region of the support, and a release layer 8 disposed the entire surface of the support covering the thermosensitive recording layer 2, a printed layer 4 disposed on a partial region of a back surface of the support 1, and an adhesive layer 7 disposed on the entire back surface of the support covering the printed layer. The thermosensitive recording medium of the twenty-fifth embodiment may further include a protective layer.

### Twenty-Sixth Embodiment

FIG. 26A is a schematic cross-sectional view illustrating an example of the thermosensitive recording medium of the twenty-sixth embodiment. FIG. 26B is a schematic plan view (a surface of a support) illustrating the example of the thermosensitive recording medium of the twenty-sixth embodiment.

The thermosensitive recording medium of the twenty-sixth embodiment includes a support 1, and a black thermosensitive recording layer 2b, a region with no thermosensitive recording layer (the support 1), and a blue thermosensitive recording layer 2c disposed on the support 1.

### Twenty-Seventh Embodiment

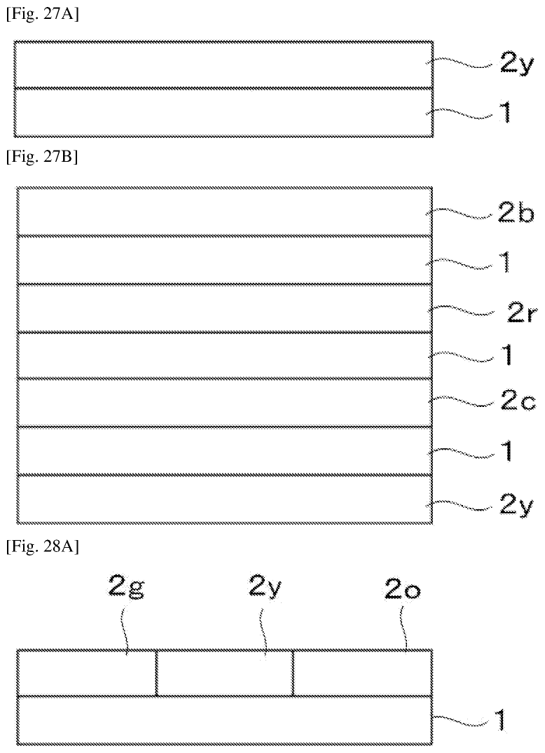

FIG. 27A is a schematic cross-sectional view illustrating an example of the thermosensitive recording medium of the twenty-seventh embodiment. FIG. 27B is a schematic plan view (a surface of a support) illustrating the example of the thermosensitive recording medium of the twenty-seventh embodiment.

The thermosensitive recording medium of the twenty-seventh embodiment includes a support 1, and a black thermosensitive recording layer 2b, a region with no thermosensitive recording layer (the support 1), a red thermosensitive recording layer 2r, another region with no thermosensitive recording layer (the support 1), a blue thermosensitive recording layer 2c, yet another region with no thermosensitive recording layer (the support 1), and a yellow thermosensitive recording layer 2y.

### Twenty-Eighth Embodiment

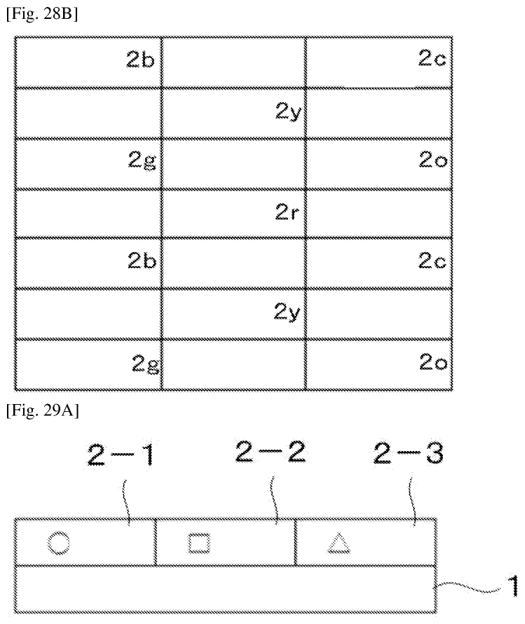

FIG. 28A is a schematic cross-sectional view illustrating an example of the thermosensitive recording medium of the twenty-eighth embodiment. FIG. 28B is a schematic plan view (a surface of a support) illustrating the example of the thermosensitive recording medium of the twenty-eighth embodiment.

The thermosensitive recording medium of the twenty-eighth embodiment includes a region with no thermosensitive recording layer (the support 1), a black thermosensitive recording layer 2b, another region with no thermosensitive recording layer (the support 1), a green thermosensitive recording layer 2g, yet another region with no thermosensitive recording layer (the support 1), a black thermosensitive recording layer 2b, yet another region with no thermosensitive recording layer (the support 1), and a green thermosensitive recording layer 2g. Moreover, the thermosensitive recording medium of the twenty-eighth embodiment includes a region with no thermosensitive recording layer (the support 1), a yellow thermosensitive recording layer 2y, another region with no thermosensitive recording layer (the support 1), a red thermosensitive recording layer 2r, yet another region with no thermosensitive recording layer (the support 1), a yellow thermosensitive recording layer 2y, and a region with no thermosensitive recording layer (the support 1). Furthermore, the thermosensitive recording medium of the twenty-eighth embodiment includes a blue thermosensitive recording layer 2c, a region with no thermosensitive recording layer (the support 1), an orange thermosensitive recording layer 2o, a region with no thermosensitive recording layer (the support 1), a blue thermosensitive recording layer 2c, a region with no thermosensitive recording layer (the support 1), and an orange thermosensitive recording layer 2o.

### Twenty-Ninth Embodiment

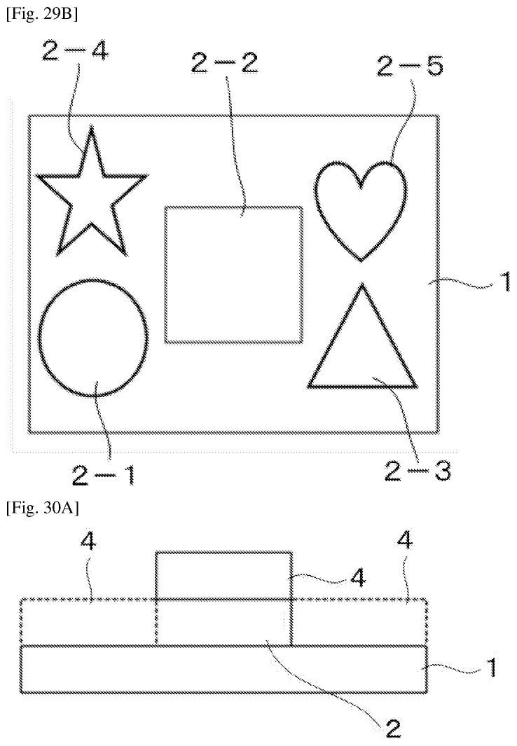

FIG. 29A is a schematic cross-sectional view illustrating an example of the thermosensitive recording medium of the twenty-ninth embodiment. FIG. 29B is a schematic plan view (a surface of a support) illustrating the example of the thermosensitive recording medium of the twenty-ninth embodiment.

The thermosensitive recording medium of the twenty-ninth embodiment includes a support 1, and a circular thermosensitive recording layer 2-1, a square thermosensitive recording layer 2-2, a triangular thermosensitive recording layer 2-3, a star-shaped thermosensitive recording layer 2-4, and a heart-shaped thermosensitive recording layer 2-5 disposed on the support 1.

### Thirtieth Embodiment

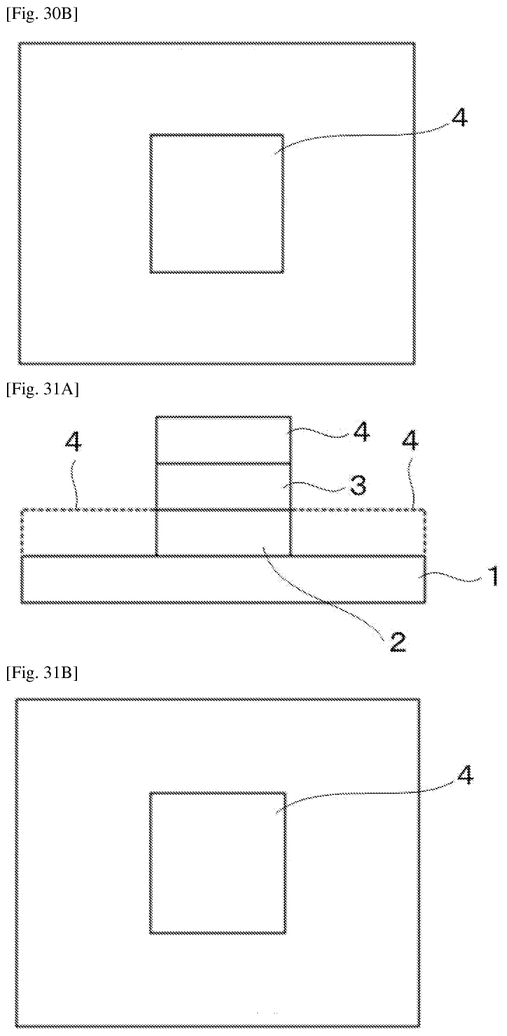

FIG. 30A is a schematic cross-sectional view illustrating an example of the thermosensitive recording medium of the thirtieth embodiment. FIG. 30B is a schematic plan view (a surface of a support) illustrating the example of the thermosensitive recording medium of the thirtieth embodiment.

The thermosensitive recording medium of the thirtieth embodiment is identical to the ninth embodiment, except that a printed layer 4 is disposed on the surface of the support 1 and above the thermosensitive recording layer 2.

### Thirty-First Embodiment

FIG. 31A is a schematic cross-sectional view illustrating an example of the thermosensitive recording medium of the thirty-first embodiment. FIG. 31B is a schematic plan view (a surface of a support) illustrating the example of the thermosensitive recording medium of the thirty-first embodiment.

The thermosensitive recording medium of the thirty-first embodiment is identical to the twelfth embodiment, except that a printed layer 4 is disposed on the surface of the support 1 and above the protective layer 3.

### Thirty-Second Embodiment

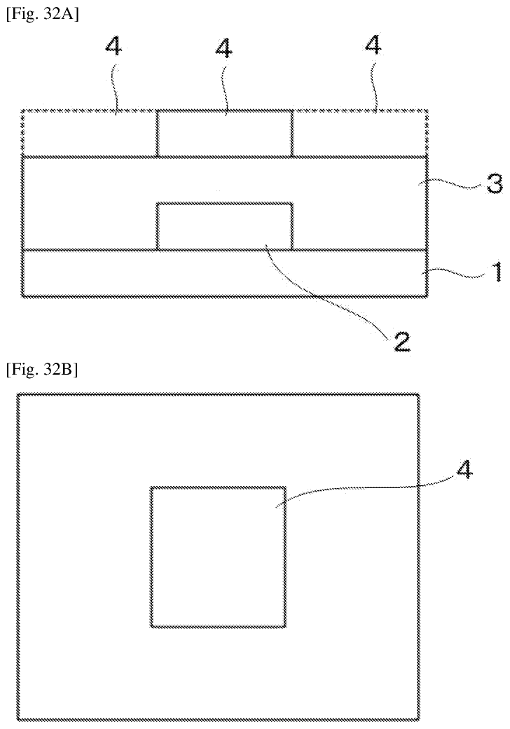

FIG. 32A is a schematic cross-sectional view illustrating an example of the thermosensitive recording medium of the thirty-second embodiment. FIG. 32B is a schematic plan view (a surface of a support) illustrating the example of the thermosensitive recording medium of the thirty-second embodiment.

The thermosensitive recording medium of the thirty-second embodiment is identical to the thirteenth embodiment, except that a printed layer 4 is disposed above the protective layer 3.

### (Image Recording Method)

The image recording method of the present disclosure includes heating the thermosensitive recording medium of the present disclosure with a thermal head to record an image.

A shape, structure, size, etc. of the thermal head are not particularly limited and may be appropriately selected depending on the intended purpose.

In this case, a protective layer is preferably disposed on the thermosensitive recording layer considering preservability of the thermosensitive recording layer, and conformity with a thermal head. A protective layer is not necessarily disposed if a color developer having high image and background preservability is used, and conformity with a thermal head can be imparted directly to the thermosensitive recording layer by filler, a lubricant, etc.

When filler is added to the protective layer or thermosensitive recording layer to achieve conformity with a thermal head, the thermal head cannot be brought into close contact with the protective layer or thermosensitive recording layer, which is the original intention, if the 50% cumulative volume particle diameter (D₅₀) of the filler as measured by a laser diffraction/scattering particle size analyzer (device name: LA-960, available from Horiba, Ltd.) is too small. When the particle diameter of the filler is too large, the thermal head tends to be abraded and transparency cannot be secured easily. Therefore, the particle diameter of the filler is preferably, but is not limited to, in the approximate range of from 0.25 micrometers through 0.75 micrometers.

The image recording method of the present disclosure includes irradiating the thermosensitive recording medium of the present disclosure with laser light to record an image.

Various units may be used as a heating unit using laser light, but use of a laser light that can heat the thermosensitive recording medium without contact is preferable.

The laser light is not particularly limited and may be appropriately selected depending on the intended purpose. For example, various laser devices generally known in the art, such as a gas laser using gas (e.g. CO₂), a solid laser using a solid (e.g., YAG and YVO₄), and a semiconductor laser using a Group III-V semiconductor or Group IV-VI semiconductor, may be used. The laser device for use may be appropriately selected depending on the intended use and method.

Among the above-listed examples, the CO₂ laser emits light having a wavelength of 10,000 nm, which can be absorbed by general materials, and is actively utilized in a method that can perform thermosensitive recording without any particular absorbing materials.

When a photothermal conversion material, which is a material absorbing laser light having a wavelength of from 800 nm through 1,100 nm emitted from a semiconductor laser, YAF solid layer, or fiber layer to convert into heat, is added, moreover, as well as directly applying laser light to the thermosensitive recording layer, laser light can be also applied from the side of a transparent film, as the transparent plastic film, such as PET, and OPP does not absorb the laser light having a wavelength of from 800 nm through 1,100 nm. Therefore, the laser light can be applied from the side of the transparent film to record the thermosensitive recording layer disposed to the opposite side of the film, which leads to versatility of the thermosensitive recording medium in terms of use.

The output of laser light emitted from the image forming device in the image forming step is not particularly limited and may be appropriately selected depending on the intended purpose. The output thereof is preferably 1 W or greater, more preferably 3 W or greater, and particularly preferably 5 W or greater. When the output is less than 1 W, it may take a long time to form an image, and output becomes insufficient if the image formation time is shortened.

Moreover, the upper limit of the output of the laser light is not particularly limited and may be appropriately selected depending on the intended purpose. The upper limit thereof is preferably 200 W or less, more preferably 150 W or less, and particularly preferably 100 W or less. When the upper limit thereof is greater than 200 W, a size of a laser device used may be large.

In the case where image recording is performed on a thermosensitive recording medium at high speed, moreover, an image forming device including a laser array, in which laser light emitting elements are aligned into an array, is preferably used.

Next, as an example, a laser recording device that records an image on a long thermosensitive recording medium will be described.

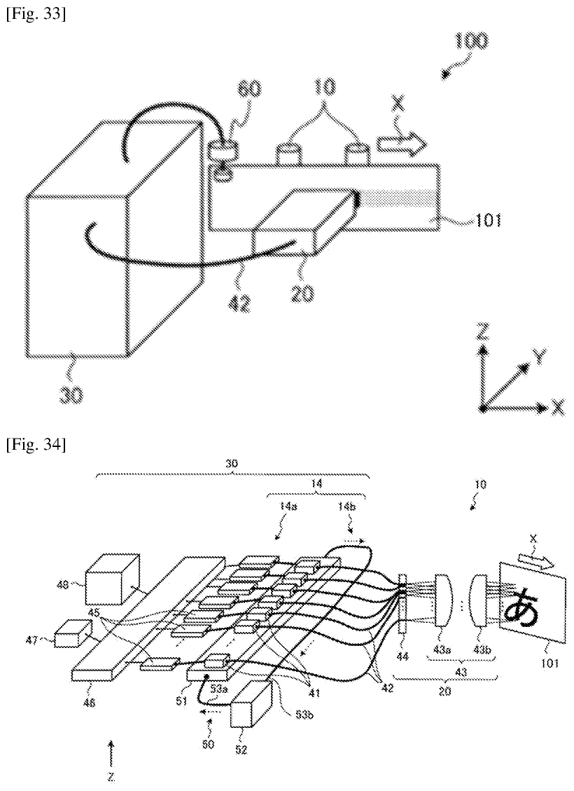

FIG. 33 is a schematic perspective view illustrating an image recording system 100 that is a laser recording device.

In the description below, a conveying direction (traveling direction) of the thermosensitive recording medium is described as an X axial direction, the up-down direction is described as a Z axial direction, and the direction orthogonal to both the traveling direction and the up-down direction is described as a Y axial direction.

As described below, the image recording system 100 irradiates the thermosensitive recording medium 101 that is a recording target with laser light to perform a surface processing treatment, or an image recording process.

As illustrated in FIG. 33, the image recording system 100 includes a conveyance device 10, a recording device 20, a main body 30, an optical fiber 42, and an encoder 60.

The recording device 20 is configured to irradiate the recording target, which is the thermosensitive recording medium 101, with laser light to perform a processing treatment on a surface of the recording target, or record an image that is a visible image on the recording target. The recording device 20 corresponds to a laser irradiation device. The recording device 20 is disposed at the side of −Y axial direction relative to the conveyance device 10, specifically the −Y direction along the conveying path.

For example, the conveyance device 10 is configured to transport the thermosensitive recording medium 101 that is the recording target using a plurality of rotating rollers. The main body 30 is connected with the conveyance device 10, and the recording device 20, and is configured to control the entire image recording system 100. The encoder 60 is configured to acquire the traveling speed of the thermosensitive recording medium 101.

FIG. 34 is a schematic perspective view illustrating a structure of the image recording system 100.

The image recording system 100 includes a laser processing device 30 that is a laser light source. The laser processing device 30 includes a laser irradiation device 14 and an optical unit 43. The laser irradiation device 14 includes a laser array unit 14a and a fiber array unit 14b. As the laser irradiation device 14, a fiber array recording device is used. The fiber array recording device is configured to perform a surface processing treatment or image recording using a fiber array where a plurality of optical fiber laser emitters are aligned into an array along the main scanning direction (Z axial direction) orthogonal to the sub-scanning direction (X axial direction) that is the traveling direction of the thermosensitive recording medium 101 serving as the recording target. The laser processing device 30 is configured to apply laser light emitted from the laser light emitting element 41 to the thermosensitive recording medium 101 via the fiber array to record an image (visible image) formed of drawing units.

The laser array unit 14a includes a plurality of laser light emitting elements 41 aligned into an array, a cooling unit 50 configured to cool the laser light emitting elements 41, a plurality of driving drivers 45 disposed to correspond to the laser light emitting element 41 and configured to drive the corresponding the laser light emitting elements 41, and a controller 46 configured to control the driving drivers 45. The controller 46 is connected to a power source 48 configured to supply electricity to the laser light emitting elements 41, and an image information output unit 47, such as a personal computer for outputting image information.

In the laser light emitting element 41, typically, the energy that is not converted into laser light is converted into heat, thus the laser light emitting element 41 generates heat. Therefore, the laser light emitting element 41 is cooled by the cooling unit 50 that is a cooling device. Since the laser irradiation device 14 uses the fiber array unit 14b, moreover, the laser light emitting elements 41 can be disposed being separated from one another. As a result, the influence of heat from the adjacent laser light emitting element 41 can be minimized, and the laser light emitting elements 41 can be effectively cooled. Therefore, increase in the temperature of each laser light emitting element 41, and variation in the temperatures of the laser light emitting elements 41 can be avoided, variation in the output of laser light can be minimized, and density unevenness can be improved. The output of laser light is the average output measured by a power meter. As a method for controlling output of laser light, there are two methods, which are a method for controlling peak power, and a method for controlling a light emission ratio of a pulse (duty: laser light emitting time/cycle period). The cooling unit 50 employs a liquid cooling system where a coolant is circulated to cool the laser light emitting elements 41. The cooling unit 50 includes a heat-receiving unit 51 where the coolant receives the heat from each of the laser light emitting elements 41, and a heat-releasing unit 52 where the heat of the coolant is released. The heat-receiving unit 51 and the heat-releasing unit 52 are connected with each other via cooling pipes 53a and 53b. The heat-receiving unit 51 includes a case formed of a highly heat conductive member, and a cooling tube formed of a highly heat conductive member, where the cooling tube is disposed inside the case, and the coolant is circulated through the cooling tube. The laser light emitting elements 41 are aligned into an array on the heat-receiving unit 51.

The heat-releasing unit 52 includes a radiator, and a pump for circulating the coolant. The coolant sent out by the pump of the heat-releasing unit 52 is flown into the heat-receiving unit 51 via the cooling pipe 53a. As the coolant travels through the cooling tube inside the heat-receiving unit 51, the coolant takes out the heat of the laser light emitting elements 41 aligned on the heat-receiving unit 51 to cool the laser light emitting elements 41. The coolant the temperature of which has been increased by absorbing the heat of the laser light emitting elements 41 is flown out from the heat-receiving unit 41, and travels inside the cooling pipe 53b to flow into the radiator of the heat-releasing unit 52. The coolant is then cooled by the radiator. The coolant cooled by the radiator is again sent out to the heat-receiving unit 51 by the pump. The fiber array unit 14b includes optical fibers 42 disposed to correspond to the laser light emitting elements 41, and an array head 44 configured to hold the optical fibers 42 aligned into an array along the up-down direction (Z axial direction) at around the laser emitters 42a of the optical fibers 42. A laser receiver of each optical fiber 42 is disposed on the laser emitting surface of the corresponding laser light emitting element 41.

When all of the optical fibers 42 are held with one array head 44, the array head 44 becomes long, and is easily deformed. As a result, it is difficult to maintain the straight linear beam alignment and uniformity of beam pitch with only one array head 44. Therefore, each array head 44 holds from 100 through 200 optical fibers 42. The laser irradiation device 14 preferably includes a plurality of array heads 44, each of which holds from 100 through 200 optical fibers 42, where the array heads 44 are disposed and aligned along the Z axial direction that is the direction orthogonal to the traveling direction of the thermosensitive recording medium 101.

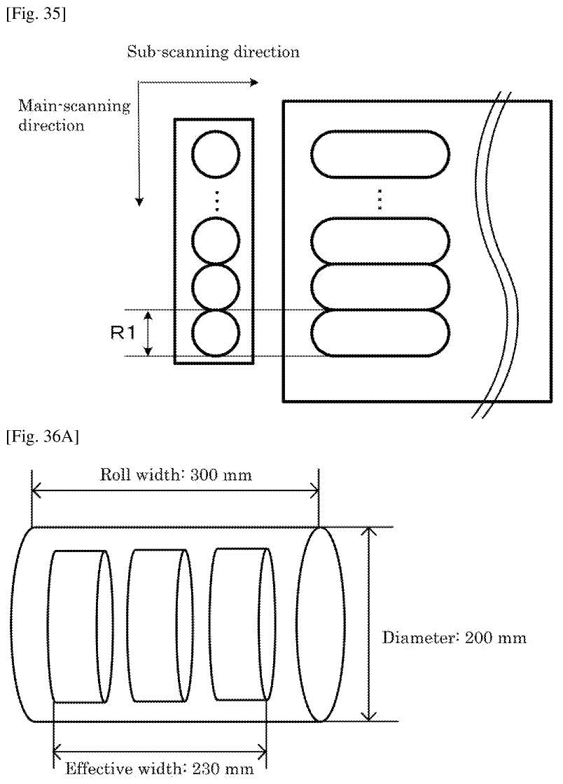

FIG. 35 is a view illustrating an alignment state of the laser array. As illustrated in FIG. 35, the optical fibers 42 of the array head 44 of FIG. 34 are aligned to continuously link dots of diameter R1 formed by emitting laser to color the thermosensitive recording medium at the focal point position created by converging by the optical unit 43.

As the scanning direction of laser light, there are a main-scanning direction and a sub-scanning direction, and the main-scanning direction and the sub-scanning direction are orthogonal to each other. The main-scanning direction is a direction along which a plurality of the optical fiber 42 are aligned. The sub-scanning direction is a direction along which the thermosensitive recording medium travels.

Since an image is recording on the thermosensitive recording medium by relatively moving the array head 44 and the thermosensitive recording medium, the array head 44 may be moved relative to the thermosensitive recording medium, or the thermosensitive recording medium may be moved relative to the array head 44. Even when the array head 44 is moved relative to the thermosensitive recording medium, the phrase “traveling speed of the thermosensitive recording medium” is used with using the array head 44 as an observation point.

As illustrated in FIG. 34, moreover, the optical unit 43, which is an example of an optical system, includes a collimator lens 43a configured to convert a diffusing flux of laser light emitted from the optical fibers 42 into a parallel luminous flux, and a condenser lens 43b configured to converge the laser light to illuminate a surface of the thermosensitive recording medium that is a laser irradiation surface. Whether the optical unit 43 is disposed or not may be appropriately decided depending on the intended purpose.

The image information output unit 47, such as a personal computer, is configured to input image information to the controller 46. The controller 46 is configured to generate a driving signal (control pulse) for driving each driver 45 based on the input image information. The controller 46 is configured to transmit the generated driving signal (control pulse) to each driving driver 45. Specifically, the controller 46 includes a clock generator. The controller 46 transmits a driving signal (control pulse) for each driver 45 to the driver 45 when the clock frequency oscillated by the clock generator reaches the predetermined clock frequency.

Once each driver 45 receives the driving signal (control pulse), the driver 45 transmits a current pulse to drive the corresponding laser light emitting element 41. As driven by the driver 45, the laser light emitting element 41 outputs a luminous pulse to emit laser light. The laser light emitted from the laser light emitting element 41 enters the corresponding optical fiber 42 to be emitted from the laser emitter 42a of the optical fiber 42. The laser light emitted from the laser emitter 42a of the optical fiber 42 is passed through the collimator lens 43a and the condenser lens 43b of the optical unit 43, followed by being applied to the thermosensitive recording medium, which is a recording target. The thermosensitive recording medium is heated by the applied laser light to record an image on the thermosensitive recording medium.

When a device configured to deflect laser light with a galvanometer mirror to record an image in a recording target is used, an image, such as a letter, is recorded by applying laser light to draw the image with one stroke by rotating the galvanometer mirror. In the case where a certain amount of information is recorded in a recording target, therefore, recording cannot catch up with the traveling speed of the recording target, unless the recording target is stopped being transported.

Meanwhile, the laser irradiation device 14 uses a laser array, in which a plurality of laser light emitting elements 41 are aligned into an array, and therefore an image can be recorded on the thermosensitive recording medium by controlling on and off of the laser light emitting element for each pixel. As a result, an image can be recorded on the thermosensitive recording medium without stopping the transportation of the thermosensitive recording medium even when an amount of information to be recorded is large. Accordingly, use of the laser irradiation device 14 can realize recording of an image without lowering productivity even when a large amount of information is recorded in a recording target.

The laser irradiation device 14 is configured to apply laser light to the thermosensitive recording medium to heat the thermosensitive recording medium to record an image on the thermosensitive recording medium. Therefore, the laser irradiation device 14 is desired to have laser light emitting elements 41 of relatively high output. For this reason, the laser light emitting elements 41 generate a large quantity of heat. In a conventional laser array recording device that does not have a fiber array unit 14b, it is desired to arrange the laser light emitting elements 41 into an array at the pitch corresponding to the resolution. In order to achieve the resolution of 200 dpi, therefore, the laser light emitting elements 41 are arranged at a very narrow pitch in a conventional laser array recording device. As a result, heat generated from the laser light emitting elements 41 is not easy to be released inside the conventional laser array recording device, and the laser light emitting elements 41 tend to be heated at a high temperature. As the temperature of the laser light emitting element 41 increases in the conventional laser array recording device, the wavelength of light emitted from the laser light emitting element 41 or luminous output of the laser light emitting element 41 fluctuates, and therefore the laser array recording device cannot heat a recording target to the predetermined temperature. As a result, an excellent image cannot be obtained. In order to suppress such increase in the temperature of the laser light emitting element 41 of the conventional laser array recording device, it is important to secure a sufficient gap between emissions of the laser light emitting elements 41 by reducing the transportation speed of the recording target, and therefore productivity cannot be enhanced sufficiently.

Typically, the cooling unit 50 often employs a chiller system. In the chiller system, only cooling is performed without performing heating. Therefore, the temperature of the light source does not exceed the set temperature of the chiller, but the temperature of the cooling unit 50 and the temperature of the laser light emitting element 41 to be in contact with the cooling unit 50 are fluctuated by the surrounding temperature. When a semiconductor laser is used as the laser light emitting element 41, meanwhile, laser output varies depending on the temperature of the laser light emitting element 41 (the laser output is high when temperature of the laser light emitting element 41 is a low temperature). In order to control laser output, therefore, a temperature of the laser light emitting element 41 or a temperature of the cooling unit 50 is preferably measured, and an input signal to the driver 45 for controlling the laser output is controlled based on the measured temperature to make the laser output constant to thereby perform regular image formation.

On the other hand, the laser irradiation device 14 is the fiber array recording device using the fiber array unit 14b. Since the fiber array recording device is used, the laser emitter 42a of the fiber array unit is arranged at the pitch corresponding to the resolution, and it is not necessary to arrange the laser light emitting elements of the laser array unit 14a at the pitch corresponding to the image resolution. Therefore, heat of the laser light emitting elements 41 of the laser irradiation device 14 is sufficiently released, and the pitch of the laser light emitting elements 41 can be made sufficiently wide. According to the laser irradiation device 14, the laser light emitting element 41 is prevented from being heated to a high temperature, and variations in the wavelength or output of the laser light emitting element 41 can be prevented. As a result, the laser irradiation device 14 can record an excellent image on the thermosensitive recording medium. Even when the emission pitch of the laser light emitting elements 41 is shorten, an increase in the temperature of the laser light emitting elements 41 can be prevented, and thus the traveling speed of the thermosensitive recording medium can be increased, thus increasing productivity.

Since the cooling unit 50 is disposed in the laser irradiation device 14 to cool the laser light emitting element 41 with a liquid, therefore, an increase in the temperature of the laser light emitting element 41 can be prevented further. As a result, the laser irradiation device 14 can further shorten emission gap of the laser light emitting elements 41, and the traveling speed of the thermosensitive recording medium can be increased, and the productivity can be enhanced. In the laser irradiation device 14, the laser light emitting elements 41 are cooled with a liquid, but the laser light emitting elements 41 may be cooled with air by a cooling fan etc. However, the liquid cooling has advantages that the liquid cooling has the higher cooling efficiency than the air cooling, and the laser light emitting element 41 can be cooled well. On the other hand, the air cooling has an advantage that the laser light emitting elements 41 can be cooled at low cost through the air cooling has the cooling efficiency inferior to the liquid cooling.

### EXAMPLES

The present disclosure will be described more specifically below by way of Examples. The present disclosure should not be construed as being limited to these Examples.

### <Measurement of Solubility of Electron-Accepting Compound to Solvent>

### «1. Preparation of Saturated Solution»

(1) In the environment of 20° C.±3° C., about 100 g of a solvent (100% ethanol) was prepared in a 150 mL to 300 mL beaker.

(2) While stirring a stirrer or a stirring rod, an electron-accepting compound was added gradually until insoluble matter of the electron-accepting compound appears at the bottom of the beaker.

(3) The resultant was left to stand for 1 hour or longer with a lid placed on top of the beaker.

(4) If the insoluble matter was completely disappeared by stirring with the stirring rod, the processes (2) to (4) were repeated.

(5) If the insoluble matter was remained after standing for 1 hour or longer, it was determined that preparation of a saturated solution was completed.

### «2. Measurement of Solubility»

A weight (A) of an aluminium cup was weighed with the minimum unit of 1 mg or less.

The part of the transparent supernatant liquid of the saturated solution prepared in 1 was collected by a pipette, and the collected liquid was placed in the aluminium cup (about 0.8 g to about 1.3 g in weight) and a weight of the liquid was weighed with the minimum unit of 1 mg or less.

The measurement was promptly performed in order to prevent inclusion of dusts etc.

The aluminium cup in which the liquid was collected was placed in a dryer (120° C.±10° C.). Alternatively, the aluminium cup in which the liquid was collected is placed on a hot plate (120° C.±10° C.) in an area where a local ventilation was installed.

The solvent was evaporated from the liquid for 25 minutes or longer (a lid was placed to prevent inclusion of dusts when a hot plate was used).

The aluminium cup was removed from the drier or hot plate, and was left to stand for 1 minute or longer indoor, followed by weighing the total amount (C) with a unit of 1 mg or less.

Based on the measurement results of A, B, and C above, the solubility of the electron-accepting compound to ethanol was calculated according to the following mathematical equation 1.

$$Solubility ( \% by mass ) = [ ( C - A ) / B ] \times 100 \qquad Mathematical Equation 1$$

TABLE 1

| | | Solubility (% by mass) | | | | | |
|---|---|---|---|---|---|---|---|
| | | | | | | Ketone | |
| | | | | | Ester | solvent | |
| | | Alcohol solvent | | | solvent | methyl | Aromatic |
| Electron-accepting compound | | | | isopropyl | ethyl | ethyl | solvent |
| No. | Type | ethanol | methanol | alcohol | acetate | ketone | toluene |
| 1 | Electron-Accepting Compound 6 | 34.1 | 33.7 | 34.1 | 9.7 | 36.5 | 0.1 |
| 2 | Electron-Accepting Compound 1 | 4.7 | 24.8 | 4.5 | 9.0 | 30.2 | 0.7 |
| 3 | Electron-Accepting Compound 2 | 2.3 | 4.0 | 1.2 | 3.3 | 21.7 | 0.1 |
| 4 | Electron-Accepting Compound 3 | 0.6 | 0.6 | 0.8 | 1.6 | 8.1 | 0.1 |
| 5 | Electron-Accepting Compound 4 | 0.4 | 0.8 | 0.4 | 2.1 | 12.7 | 0.1 |
| 6 | Electron-Accepting Compound 5 | 0.1 | 0.1 | 0.1 | 1.3 | 11.3 | 0.1 |

It was found from the results of Table 1 that the solubility of the nonphenolic electron-accepting compound to the alcohol solvent and the ester solvent was low.

Although the solubility of the electron-accepting compound to the aromatic solvent, such as toluene, is low, use of the aromatic solvent is restricted in the printed industry for the purpose of reducing the environmental loads through discharge of VOC.

The detail of the electron-accepting compounds in Table 1 are as follows.

### -Electron-Accepting Compound 1-

9,9-Bis(4-hydroxyphenyl)fluorene

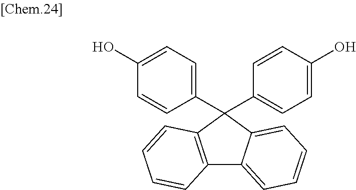 [SMILES: Oc1ccc(C2(c3ccc(O)cc3)c3ccccc3-c3ccccc32)cc1]

### -Electron-Accepting Compound 2-

N-(2-(3-phenylureido)phenyl)benzenesulfoneamide

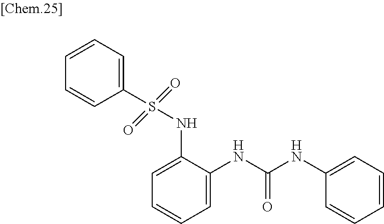 [SMILES: O=C(Nc1ccccc1)Nc1ccccc1NS(=O)(=O)c1ccccc1]

### -Electron-Accepting Compound 3-

N-benzyl-N′-3-(p-toluenesulfonyloxyphenyl)urea

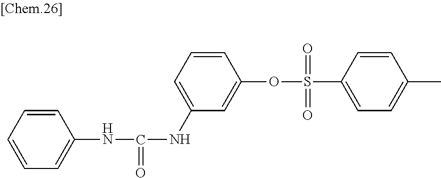 [SMILES: Cc1ccc(S(=O)(=O)Oc2cccc(NC(=O)Nc3ccccc3)c2)cc1]

### -Electron-Accepting Compound 4-

N-p-toluenesulfonyl-N′-3-(p-toluenesulfonyloxyphenyl)urea

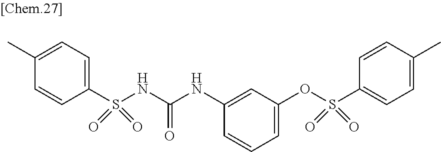

### -Electron-Accepting Compound 5-

N,N′-di-[3-(p-toluenesulfonyloxy)phenyl]urea

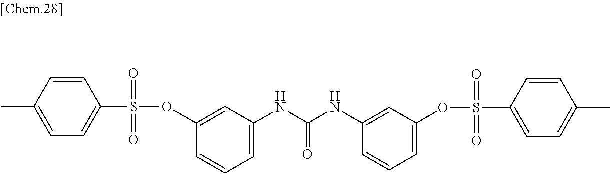

### -Electron-Accepting Compound 6-

Bisphenol-S: 4,4′-sulfonylbisphenol

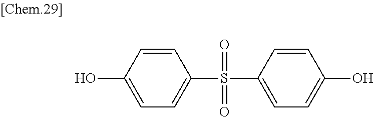 [SMILES: O=S(=O)(c1ccc(O)cc1)c1ccc(O)cc1]

### Example 1

-Preparation of Thermosensitive Recording Layer Forming Liquid (without Photothermal Conversion Material)-

A black dye (ODB2, available from Yamamoto Chemicals, Inc.) (6.2 parts by mass) serving as an electron-donating compound, 18.7 parts by mass of Electron-Accepting Compound 1, 40.0 parts by mass of an acryl resin (A-1125, available from DSM, an aqueous solution having the solid content of 19.5% by mass), 4.6 parts by mass of a styrene-acryl resin (JONCRYL PDX-7741, available from BASF SE, an aqueous solution having the solid content of 41.5% by mass), 1.9 parts by mass of a surfactant (PD-001, available from Nissin Chemical Co., Ltd., the solid content: 10% by mass), 15 parts by mass of water, and 13.6 parts by mass of ethanol were dispersed by means of a sand mill so that the 50% cumulative volume particle diameter (D₅₀) of the dispersed elements as measured by a laser diffraction/scattering particle size analyzer (device name: LA-960, available from Horiba, Ltd.) was to be 0.25 micrometers, to thereby obtain Thermosensitive Recording Layer Forming Liquid 1 (without photothermal conversion material, solid content: 36% by mass, ethanol content in the solvent: 21% by mass).

### Comparative Example 1

Thermosensitive Recording Layer Forming Liquid 11 was obtained in the same manner as in Example 1, except that Electron-Accepting Compound 1 was replaced with Electron-Accepting Compound 6 presented in Table 2, and 15 parts by mass of water and 13.6 parts by mass of ethanol were replaced with 28.6 parts by mass of water.

### Examples 2 to 4 and Comparative Example 2

Thermosensitive Recording Layer Forming Liquids 2 to 4 and 12 (without photothermal conversion material, solid content: 36% by mass, ethanol content in the solvent: 34% by mass) were each prepared in the same manner as in Example 1, except that Electron-Accepting Compound 1 was replaced with the electron-accepting compound presented in Table 2, and 15 parts by mass of water and 13.6 parts by mass of ethanol were replaced with 7 parts by mass of water and 21.6 parts by mass of ethanol.

### Example 5

Thermosensitive Recording Layer Forming Liquid 5 (without photothermal conversion material, solid content: 36% by mass, ethanol content in the solvent: 45% by mass) was obtained in the same manner as in Example 1, except that Electron-Accepting Compound 1 was replaced with Electron-Accepting Compound 5 presented in Table 2, and 15 parts by mass of water and 13.6 parts by mass of ethanol were replaced with 0 parts by mass of pure water, and 28.6 parts by mass of ethanol.

### Example 6

Thermosensitive Recording Layer Forming Liquid 6 (without photothermal conversion material, solid content: 36% by mass, methanol content in the solvent: 45% by mass) was obtained in the same manner as in Example 5, except that ethanol was replaced with methanol.

### Example 7

Thermosensitive Recording Layer Forming Liquid 7 (without photothermal conversion material, solid content: 36% by mass, isopropyl alcohol content in the solvent: 45% by mass) was obtained in the same manner as in Example 5, except that ethanol was replaced with isopropyl alcohol.

### Examples 8 to 9

Thermosensitive Recording Layer Forming Liquids 8 to 9 (without photothermal conversion material, solid content: 36% by mass, ethanol content in the solvent: 45% by mass) were each obtained in the same manner as in Example 5, except that the electron-donating compound was replaced with the electron-donating compound presented in Table 2.

### Example 10

-Preparation of Thermosensitive Recording Layer Forming Liquid (with Photothermal Conversion Material)-

Thermosensitive Recording Layer Forming Liquid 10 (with photothermal conversion material, solid content: 36% by mass, ethanol content in the solvent: 45% by mass) was obtained in the same manner as in Example 5, except that 6 parts by mass of a cesium tungsten oxide dispersion (YMW-D20, available from Sumitomo Metal Mining Co., Ltd., an aqueous solution having the solid content of 28.5% by mass) was added to 100 parts by mass of the thermosensitive recording layer forming liquid (without photothermal conversion material) prepared in Example 5.

TABLE 2

| | Thermosensitive | Electron-accepting | | | | |
|---|---|---|---|---|---|---|
| | recording | compound | | | | |
| | layer | | Solubility | Electron- | Photothermal | |
| | forming | | to ethanol | donating | conversion | Solvents |
| | liquid No. | No. | (% by mass) | compound | material | included |
| Ex. 1 | 1 | 1 | 4.7 | ODB2 | not present | water/ethanol |
| Ex. 2 | 2 | 2 | 2.3 | ODB2 | not present | water/ethanol |
| Ex, 3 | 3 | 3 | 0.6 | ODB2 | not present | water/ethanol |
| Ex. 4 | 4 | 4 | 0.4 | ODB2 | not present | water/ethanol |
| Ex. 5 | 5 | 5 | 0.1 | ODB2 | not present | water/ethanol |
| Ex. 6 | 6 | 5 | 0.1 | ODB2 | not present | water/methanol |
| Ex. 7 | 7 | 5 | 0.1 | ODB2 | not present | water/isopropyl |
| | | | | | | alcohol |
| Ex. 8 | 8 | 5 | 0.1 | RED40 | not present | water/ethanol |
| Ex. 9 | 9 | 5 | 0.1 | BLUE63 | not present | water/ethanol |
| Ex. 10 | 10 | 5 | 0.1 | ODB2 | present | water/ethanol |
| Comp. | 11 | 6 | 34.1 | ODB2 | not present | water |
| Ex. 1 | | | | | | |
| Comp. | 12 | 6 | 34.1 | ODB2 | not present | water/ethanol |
| Ex. 2 | | | | | | |

The details of the electron-donating compounds and photothermal conversion materials in Table 2 are as follows.

### -Electron-Donating Compound-

ODB2: black dye, available from Yamamoto Chemicals, Inc.
RED40: red dye, available from Yamamoto Chemicals, Inc.
BLUE63: blue dye, available from YAMADA CHEMICAL CO., LTD.

### -Photothermal Conversion Material-

YMW-D20: cesium tungsten oxide dispersion, available from Sumitomo Metal Mining Co., Ltd.

### Preparation Example 1 of Protective Layer Forming Liquid

### -Preparation of Protective Layer Forming Liquid 1-

An acryl resin (A-1125, available from DSM, an aqueous solution having the solid content of 19.5% by mass) (100 parts by mass), and 50 parts by mass of ethanol were mixed and stirred to thereby prepare Protective Layer Coating Liquid 1 (solid content: 13% by mass, ethanol content in the solvent: 38.3% by mass).

### Preparation Example 2 of Protective Layer Forming Liquid

### <Preparation of Protective Layer Forming Liquid 2>

### -Preparation of Pigment Dispersion Liquid-

Calcium carbonate (84.2 parts by mass) serving as a pigment, 20.2 parts by mass of a styrene-acryl resin (JONCRYL PDX-7741, available from BASF SE, solid content: 41.5% by mass), 0.4 parts by mass of a surfactant (PD-001, available from Nissin Chemical Co., Ltd., solid content: 10% by mass), 51.1 parts by mass of water, and 51.1 parts by mass of ethanol were dispersed by means of a sand mill so that the 50% cumulative volume particle diameter (D₅₀) of the dispersed elements measured by a laser diffraction/scattering particle size analyzer (device name: LA-960, available from Horiba, Ltd.) was to be 0.2 micrometers, to thereby obtain a pigment dispersion liquid (solid content: 45%, ethanol content in the solvent: 44.8% by mass).

### -Preparation of Protective Layer Forming Liquid-

The pigment dispersion liquid (20.7 parts by mass), 47.7 parts by mass of an acryl resin (A-1125, available from DSM, an aqueous solution having the solid content of 19.5% by mass), 4.7 parts by mass of a lubricant (polyethylene oxide wax, an aqueous solution having the solid content of 30% by mass), 5 parts by mass of water, and 40 parts by mass of ethanol were mixed and stirred to thereby obtain Protective Layer Forming Liquid 2 (solid content: 16.9% by mass, ethanol content in the solvent: 40.8% by mass).

### Example 11

### <Production of Thermosensitive Recording Medium>

Thermosensitive Recording Layer Forming Liquid 1 was applied onto a partial region of a surface of Support 1 (White PET: polyethylene terephthalate film, CRISPER K1212, available from TOYOBO CO., LTD., average thickness: 50 micrometers) by gravure printing as described below in a manner that a deposition amount of Thermosensitive Recording Layer Forming Liquid 1 was to be 3 g/m² on dry basis, followed by drying, to form a thermosensitive recording layer, to thereby produce Thermosensitive Recording Medium 1 as illustrated in FIGS. 11A and 11B.

### <Gravure Printing>

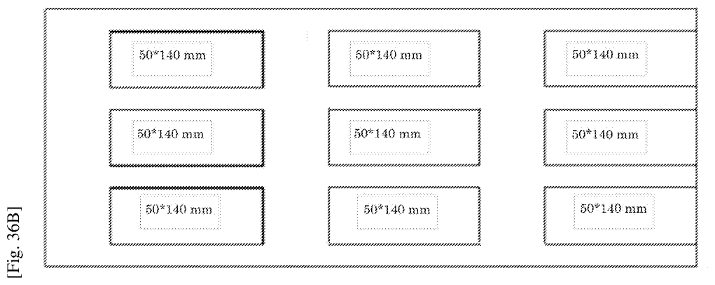

A gravure roll having engraved areas 50 lines/cm (target wet: from 7.5 g/m² through 8.5 g/m²) in the shapes illustrated in FIG. 36A, and having the outer diameter of 200 mm was prepared.

By means of a small gravure printing tester available from CHIBA MACHINE INDUSTRY CORPORATION, gravure printing was performed with the layout illustrated in FIG. 36B by setting the gravure roller, preparing 500 g of coating for each evaluation, at the linear speed of 40 m/min, and at the drying set temperature of 70° C. Then, drying was performed.

### <Flexographic Printing>

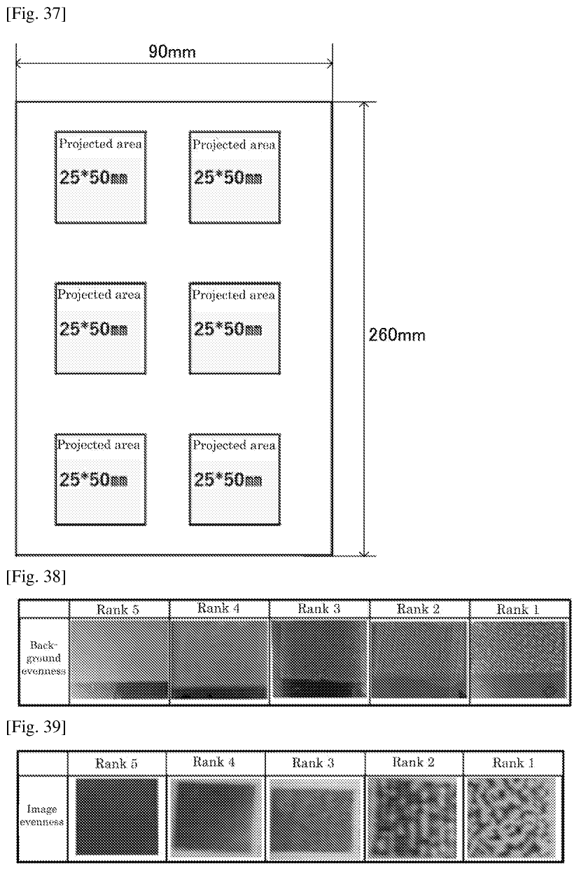

An anilox roll 50 lines/cm (target wet: from 7.5 g/m² through 8.5 g/m²), and a flexographic printing plate having a width of 90 mm, a length of 260 mm, and a thickness of 1.14 mm as illustrated in FIG. 37 were prepared.

By means of a flexographic proof printing tester available from Matsuo Sangyo Co., Ltd., printing was performed by setting the anilox roll and the flexographic printing plate, and preparing 10 g of the coating liquid for each evaluation at the linear speed of 40 m/min. The resultant was fried in a thermostat chamber set at the drying set temperature of 70° C. for 1 minute.

### Examples 12 to 19 and Comparative Examples 3 to 4

### <Production of Thermosensitive Recording Medium>

Thermosensitive Recording Media 2 to 9 and 19 to 20 as illustrated in FIGS. 11A and 11B were produced in the same manner as in Example 11, except that Thermosensitive Recording Layer Forming Liquid 1 was replaced with Thermosensitive Recording Layer Forming Liquid 2 to 9 and 11 to 12 presented in Table 3, respectively.

### Example 20

### <Production of Thermosensitive Recording Medium>

Thermosensitive Recording Medium 10 as illustrated in FIGS. 11A and 11B was produced in the same manner as in Example 15, except that Support 1 was replaced with Support 2 (transparent PET: polyethylene terephthalate film, E5100, available from TOYOBO CO., LTD., the average thickness: 50 micrometers).

### Comparative Examples 5 to 6

### <Production of Thermosensitive Recording Medium>

Thermosensitive Recording Media 21 to 22 as illustrated in FIGS. 11A and 11B were produced in the same manner as in Example 20, except that Thermosensitive Recording Layer Forming Liquid 5 was replaced with Thermosensitive Recording Layer Forming Liquids 11 to 12 presented in Table 3, respectively.

### Example 21

### <Production of Thermosensitive Recording Medium>

Thermosensitive Recording Medium 11 as illustrated in FIGS. 12A and 12B was produced in the same manner as in Example 15, except that Protective Layer Coating Liquid 1 was applied onto the thermosensitive recording layer in a manner that a deposition amount was to be 1.1 g/m² on dry basis, and the gravure printing was performed in the same manner, followed by drying to form a protective layer.

### Example 22

### <Production of Thermosensitive Recording Medium>

Thermosensitive Recording Medium 12 as illustrated in FIGS. 15A and 15B was produced in the same manner as in Example 21, except that a printed layer ink (FINART R794 White, available from DIC Corporation) was applied onto the surface of the support in the manner that a deposition amount thereof was to be 1 g/m² on dry basis through gravure printing in the same manner to form a printed layer, and the thermosensitive recording layer was formed on the printed layer, and the protective layer was formed on the thermosensitive recording layer was formed in the same manner.

### Example 23

### <Production of Thermosensitive Recording Medium>

Thermosensitive Recording Medium 13 as illustrated in FIGS. 12A and 12B was produced in the same manner as in Example 21, except that Support 1 was replaced with Support 2 (transparent PET: polyethylene terephthalate film, E5100, available from TOYOBO CO., LTD., thickness: 50 micrometers).

### Example 24

### <Production of Thermosensitive Recording Medium>

Thermosensitive Recording Medium 14 as illustrated in FIGS. 18A to 18B was produced in the same manner as in Example 23, except that a printed layer ink (FINART R794 White, available from DIC Corporation) was applied onto a back surface of the support in a manner that a deposition amount was to be 1 g/m² on dry basis through gravure printing performed in the same manner to form a printed layer.

### Example 25

### <Production of Thermosensitive Recording Medium>

Thermosensitive Recording Medium 15 as illustrated in FIGS. 19A to 19C was produced in the same manner as in Example 24, except that Protective Layer Coating Liquid 1 was applied through gravure printing under the same conditions in a manner that a deposition amount thereof in the area overlapped with the thermosensitive recording layer was to be 1.5 g/m², on dry basis, and a deposition amount thereof in the other area was to be 3 g/m² on dry basis, to form a protective layer to cover the entire thermosensitive recording medium.

### Example 26

### <Production of Thermosensitive Recording Medium>

Thermosensitive Recording Medium 16 as illustrated in FIGS. 30A and 30B was produced in the same manner as in Example 23, except that a printed layer ink (FINART R794 White, available from DIC Corporation) was applied onto the thermosensitive recording layer through gravure printing under the same conditions in a manner that a deposition amount thereof was to be 1 g/m² on dry basis, to form a printed layer.

### Example 27

### <Production of Thermosensitive Recording Medium>

Thermosensitive Recording Medium 17 as illustrated in FIGS. 19A to 19C was produced in the same manner as in Example 24, except that Protective Layer Coating Liquid 1 was replaced with Protective Layer Coating Liquid 2.

### Example 28

### <Production of Thermosensitive Recording Medium>

Thermosensitive Recording Medium 18 as illustrated in FIGS. 19A to 19C was produced in the same manner as in Example 27, except that the production method of the sample was replaced with flexographic printing described above.

### Comparative Example 7

### <Production of Thermosensitive Recording Medium>

Thermosensitive Recording Medium 23 as illustrated in FIGS. 19A to 19C was produced in the same manner as in Example 28, except that Thermosensitive Recording Layer Forming Liquid 11 was used.

Next, the detail of Thermosensitive Recording Media 1 to 23 produced are summarized in Tables 3-1 and 3-2.

TABLE 3-1

| | Thermosensitive | Thermosensitive | |
|---|---|---|---|
| | recording | recording layer | Protective layer |
| | medium | forming | coating |
| | No. | liquid No. | liquid No. |
| Ex. 11 | 1 | 1 | N/A |
| Ex. 12 | 2 | 2 | N/A |
| Ex. 13 | 3 | 3 | N/A |
| Ex. 14 | 4 | 4 | N/A |
| Ex. 15 | 5 | 5 | N/A |
| Ex. 16 | 6 | 6 | N/A |
| Ex. 17 | 7 | 7 | N/A |
| Ex. 18 | 8 | 8 | N/A |
| Ex. 19 | 9 | 9 | N/A |
| Ex. 20 | 10 | 5 | N/A |
| Ex. 21 | 11 | 5 | 1 |
| Ex. 22 | 12 | 5 | 1 |
| Ex. 23 | 13 | 5 | 1 |
| Ex. 24 | 14 | 5 | 1 |
| Ex. 25 | 15 | 5 | 1 |
| Ex. 26 | 16 | 10 | 1 |
| Ex. 27 | 17 | 5 | 2 |
| Ex. 28 | 18 | 5 | 2 |
| Comp. Ex. 3 | 19 | 11 | N/A |
| Comp. Ex. 4 | 20 | 12 | N/A |
| Comp. Ex. 5 | 21 | 11 | N/A |
| Comp. Ex. 6 | 22 | 12 | N/A |
| Comp. Ex. 7 | 23 | 5 | 2 |

TABLE 3-2

| | Printed layer | Support No. |
|---|---|---|
| Ex. 11 | Not present | 1 |
| Ex. 12 | Not present | 1 |
| Ex. 13 | Not present | 1 |
| Ex. 14 | Not present | 1 |
| Ex. 15 | Not present | 1 |
| Ex. 16 | Not present | 1 |
| Ex. 17 | Not present | 1 |
| Ex. 18 | Not present | 1 |
| Ex. 19 | Not present | 1 |
| Ex. 20 | Not present | 2 |
| Ex. 21 | Not present | 1 |
| Ex. 22 | support/printed | 1 |
| | layer/thermosensitive | |
| | recording layer | |
| Ex. 23 | Not present | 2 |
| Ex. 24 | printed layer/ | 2 |
| | support/thermosensitive | |
| | recording layer | |
| Ex. 25 | printed layer/ | 2 |
| | support/thermosensitive | |
| | recording layer | |
| Ex. 26 | support/thermosensitive | 2 |
| | recording layer/ | |
| | printed layer | |
| Ex. 27 | printed layer/ | 2 |
| | support/thermosensitive | |
| | recording layer | |
| Ex. 28 | printed layer/ | 2 |
| | support/thermosensitive | |
| | recording layer | |
| Comp. Ex. 3 | Not present | 1 |
| Comp. Ex. 4 | Not present | 1 |
| Comp. Ex. 5 | Not present | 2 |
| Comp. Ex. 6 | Not present | 2 |
| Comp. Ex. 7 | printed layer/ | 2 |
| | support/thermosensitive | |
| | recording layer | |

Next, a difference in the thickness of the thermosensitive recording layer in each of Thermosensitive Recording Media 1 to 23 was determined and uniformity of background was evaluated in the following manner. The results are presented in Tables 4-1 and 4-2.

### <Difference in Thickness of Thermosensitive Recording Layer>

The variation in the thickness of the region of the thermosensitive recording layer excluding the edge thereof was determined according to the following formula.

Variation in thickness of thermosensitive recording layer (%)=[(the maximum thickness of the thermosensitive recording layer or the minimum thickness of the thermosensitive recording layer−an average thickness of the thermosensitive recording layer)/the average thickness of the thermosensitive recording layer]×100 The thickness of the thermosensitive recording layer was measured at arbitrary selected 20 points on the thermosensitive recording medium. The maximum value was determined as “the maximum thickness of the thermosensitive recording layer” and the minimum value was determined as “the minimum thickness of the thermosensitive recording layer.” The average value of the measured values from 18 points excluding the maximum thickness of the thermosensitive recording layer and the minimum thickness of the thermosensitive recording layer among the 20 points was determined as “the average thickness of the thermosensitive recording layer.” The larger value between an absolute value of (the maximum thickness of the thermosensitive recording layer—the average thickness of the thermosensitive recording layer) and an absolute value of (the minimum thickness of the thermosensitive recording layer—the average thickness of the thermosensitive recording layer) was selected.

In Examples 11 to 20 and Comparative Examples 3 to 6, the thickness of the thermosensitive recording medium entirely along the length direction or flow direction of the thermosensitive recording medium by means of a film thickness gauge (K-402B STAND, and Electron Micrometer K351C, available from ANRITSU CORPORATION). The thickness was measured at arbitrary selected 20 points, from which the average thickness (50 micrometers) of the support measured in advance was subtracted, to thereby determine “the average thickness of the thermosensitive recording layer,” “the maximum thickness of the thermosensitive recording layer,” and “the minimum thickness of the thermosensitive recording layer.”

In Examples 21 to 28 and Comparative Example 7, the thermosensitive recording medium was cut by means of Cross section Polisher SM-0920CP (available from JEOL Ltd.) to expose a cross-section of the thermosensitive recording medium, the cross-section thereof was observed under a scanning electron microscope (SEM)S3700 (available from Hitachi High-Tech Corporation), and the thickness of the thermosensitive recording layer was measured at arbitrary selected 20 points to determine “the average thickness of the thermosensitive recording layer,” “the maximum thickness of the thermosensitive recording layer,” and “the minimum thickness of the thermosensitive recording layer.”

### <Evaluation of Uniformity of Background>

Each thermosensitive recording medium before image recording was observed with naked eyes, and the uniformity of the background was evaluated based on the following criteria and the evaluation grading table of uniformity of background depicted in FIG. 38.

### (Evaluation Criteria)

Rank 5: No coating unevenness was observed and it was uniform.
Rank 4: Slight coating unevenness was observed.
Rank 3: Coating unevenness was observed.
Rank 2: Significant coating unevenness was observed, and a few uncoated areas were confirmed.
Rank 1: Significant coating unevenness was observed, and many uncoated areas were confirmed.

### <Image Recording>

As described below, a solid image of a square in the size of 10 mm×20 mm was recorded by giving thermal gradient from the side of the thermosensitive recording layer or the side of the protective layer in Examples 11 to 24 and Comparative Examples 3 to 6. A solid image of a square in the size of 10 mm×20 mm was recorded by applying CO₂ laser light from the side of the thermosensitive recording layer in Example 25, or applying a semiconductor laser light from the side of the transparent substrate in Example 26. A solid image of a square in the size of 10 mm×20 mm was recorded by heating the thermosensitive recording medium with a thermal head from the side of the protective layer in Examples 27 and 28, and Comparative Example 7.

### «Thermal Gradient»

Printing was performed by means of a thermal gradient tester (device name: HG100-2, available from TOYO SEIKI CO., LTD.) under the following printing conditions.

### (Printing Conditions)

Temperature: 180° C.
Pressure: 2 kg/cm²
Time: 1 s

### «CO₂ Laser»

Printing was performed by means of a CO₂ laser marker (device name: LP-435TU, available from Panasonic Industrial Devices SUNX Co., Ltd.) under the following printing conditions.

### (Printing Conditions)

Work distance: 275 mm
Scanning speed: 900 mm/s
Laser light wavelength: 10.6 micrometers
Laser power: 10%

### «Semiconductor Laser»

Printing was performed by means of a LD laser marker (device name: Ricoh Rewritable Laser Marker LDM200, available from Ricoh Company Limited) under the following printing conditions.

### (Printing Conditions)

Work distance: 150 mm
Scanning speed: 3,000 mm/s
Laser light wavelength: 980 nm
Laser power: 70%

### «Thermal Printer»

Printing was performed by a thermal printer (device name: MP-104T, available from MARKPOINT) at the printing speed of 100 mm/s, and with the printing energy of 13.00 mJ/mm².

Next, each of the obtained images was evaluated on image uniformity, tailing, and background density. The results are presented in Table 4.

### <Evaluation of Image Uniformity>

Each of the obtained images was observed with naked eyes, and image uniformity thereof was evaluated according to the following criteria and the evaluation grading table of the image uniformity depicted in FIG. 39.

### (Evaluation Criteria)

Rank 5: No coating unevenness was observed in the printed area and it was uniform.
Rank 4: Slight coating unevenness was observed in the printed area.
Rank 3: Image unevenness was observed.
Rank 2: Significant image unevenness was observed, and a few uncoated areas were confirmed.
Rank 1: Significant image unevenness was observed, and many uncoated areas were confirmed.

### <Evaluation of Tailing>

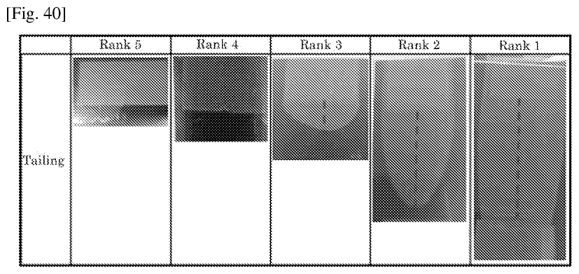

The state of tailing in the printed area and the unprinted area of each of the obtained images was observed with naked eyes, and the tailing thereof was evaluated according to the following criteria and the evaluation grading table of the image uniformity depicted in FIG. 40.

### (Evaluation Criteria)

Rank 5: There was no tailing in the printed area and the unprinted area at all.
Rank 4: The boundary between the printed area and the unprinted was slightly irregularly defined.
Rank 3: The tailing of less than 10 mm was observed in the unprinted area.
Rank 2: The tailing of 10 mm or greater but less than 30 mm was observed in the unprinted area.
Rank 1: The tailing of 30 mm or greater was observed in the unprinted area.

### <Background Density>

The background density of each of the obtained image was measured by means of a reflection densitometer (X-Rite eXact, available from X-Rite Inc.). The result was evaluated based on the following criteria. When the transparent film was used as the support, the background density was measured by placing a contrast card (Type 24/5) available from ERICHSEN GmbH & Co., KG underneath the image.

### (Evaluation Criteria)

A: 0.15 or less
B: 0.16 or greater but 0.30 or less
C: 0.31 or greater

TABLE 4-1

| | Solubility of | |
|---|---|---|
| | electron-accepting | |
| | compound to ethanol | Image recording |
| | (% by mass) | method |
| Ex. 11 | 4.7 | Thermal gradient |
| Ex. 12 | 2.3 | Thermal gradient |
| Ex. 13 | 0.6 | Thermal gradient |
| Ex. 14 | 0.4 | Thermal gradient |
| Ex. 15 | 0.1 | Thermal gradient |
| Ex. 16 | 0.1 | Thermal gradient |
| Ex. 17 | 0.1 | Thermal gradient |
| Ex. 18 | 0.1 | Thermal gradient |
| Ex. 19 | 0.1 | Thermal gradient |
| Ex. 20 | 0.1 | Thermal gradient |
| Ex. 21 | 0.1 | Thermal gradient |
| Ex. 22 | 0.1 | Thermal gradient |
| Ex. 23 | 0.1 | Thermal gradient |
| Ex. 24 | 0.1 | Thermal gradient |
| Ex. 25 | 0.1 | CO₂ laser |
| Ex. 26 | 0.1 | Semiconductor laser |
| Ex. 27 | 0.1 | Thermal printer |
| Ex. 28 | 0.1 | Thermal printer |
| Comp. | 34.1 | Thermal gradient |
| Ex. 3 | | |
| Comp. | 34.1 | Thermal gradient |
| Ex. 4 | | |
| Comp. | 34.1 | Thermal gradient |
| Ex. 5 | | |
| Comp. | 34.1 | Thermal gradient |
| Ex. 6 | | |
| Comp. | 34.1 | Thermal printer |
| Ex. 7 | | |

TABLE 4-2

| | Variation in | | | | | |
|---|---|---|---|---|---|---|
| | thickness of | | | | | |
| | thermosensitive | Background | Image | | Background density | |
| | recording layer (%) | evenness | evenness | Tailing | Value | Evaluation |
| Ex. 11 | 45 | 3 | 3 | 4 | 0.21 | B |
| Ex. 12 | 15 | 4 | 4 | 5 | 0.21 | B |
| Ex. 13 | 15 | 4 | 4 | 5 | 0.12 | A |
| Ex. 14 | 15 | 4 | 4 | 5 | 0.12 | A |
| Ex. 15 | 6 | 5 | 5 | 5 | 0.12 | A |
| Ex. 16 | 6 | 5 | 5 | 5 | 0.12 | A |
| Ex. 17 | 6 | 5 | 5 | 5 | 0.12 | A |
| Ex. 18 | 6 | 5 | 5 | 50 | 0.12 | A |
| Ex. 19 | 6 | 5 | 5 | 5 | 0.12 | A |
| Ex. 20 | 6 | 5 | 5 | 5 | 0.12 | A |
| Ex. 21 | 6 | 5 | 5 | 5 | 0.12 | A |
| Ex. 22 | 6 | 5 | 5 | 5 | 0.12 | A |
| Ex. 23 | 6 | 5 | 5 | 5 | 0.12 | A |
| Ex. 24 | 6 | 5 | 5 | 5 | 0.12 | A |
| Ex. 25 | 6 | 5 | 5 | 5 | 0.12 | A |
| Ex. 26 | 6 | 5 | 5 | 5 | 0.12 | A |
| Ex. 27 | 6 | 5 | 5 | 5 | 0.12 | A |
| Ex. 28 | 6 | 5 | 5 | 5 | 0.12 | A |
| Comp. | 200 | 1 | 1 | 1 | 0.17 | B |
| Ex. 3 | | | | | | |
| Comp. | 175 | 2 | 2 | 2 | 0.52 | C |
| Ex. 4 | | | | | | |
| Comp. | 200 | 1 | 1 | 1 | 0.17 | B |
| Ex. 5 | | | | | | |
| Comp. | 175 | 2 | 2 | 2 | 0.52 | C |
| Ex. 6 | | | | | | |
| Comp. | 200 | 1 | 1 | 1 | 0.17 | B |
| Ex. 7 | | | | | | |

For example, embodiments of the present disclosure are as follows.

<1> A thermosensitive recording layer forming liquid including:
an electron-donating compound;
an electron-accepting compound, where a solubility of the electron-accepting compound to 100% ethanol at 20° C. is 5.0% by mass or less; and a solvent.

<2> The thermosensitive recording layer forming liquid according to <1>, wherein the electron-accepting compound is at least one selected from the group consisting of compounds, each of which includes a linking group that is a (thio)urea group (—NH—CX—NH—, where X is O or S) or a sulfonyl(thio)urea group (—SO₂—NH—CX—NH—, where X is O or S), and a linking group that is an urethane group (—NHCOO—), an amide group (—NHCO—), a sulfonyl group (—SO₂—), or a sulfonylamide group (—SO₂—NH—), and has a structure in which aromatic groups are bonded via the linking groups.

<3> The thermosensitive recording layer forming liquid according to <1> or <2>, wherein the electron-accepting compound is at least one selected from the group consisting of compounds, each of which includes a linking group that is an urea group (—NH—CO—NH—), or a sulfonylurea group (—SO₂—NH—CO—NH—), and a linking group that is an amide group (—NHCO—), a sulfonyl group (—SO₂—), or a sulfonylamide group (—SO₂—NH—), and has a structure in which aromatic groups are bonded via the linking groups.

<4> The thermosensitive recording layer forming liquid according to any one of <1> to <3>, further including
a photothermal conversion material.

<5> A method for producing a thermosensitive recording medium, the method including:
applying the thermosensitive recording layer forming liquid according to any one of <1> to <4> onto a support to form a thermosensitive recording layer.

<6> The method according to <5>,
wherein the applying is applying the thermosensitive recording layer forming liquid onto a partial region of the support.

<7> A thermosensitive recording medium including:
a support; and
a thermosensitive recording layer disposed on the support, the thermosensitive recording layer including
an electron-donating compound, and
an electron-accepting compound, where a solubility of the electron-accepting compound to 100% ethanol at 20° C. is 5.0% by mass or less,
wherein a variation in a thickness of the thermosensitive recording layer represented by a formula below is 50% or less, where the variation is a variation in a region of the thermosensitive recording layer excluding an edge of the thermosensitive recording layer,
Variation in thickness of thermosensitive recording layer (%)=[(the maximum thickness of the thermosensitive recording layer or the minimum thickness of the thermosensitive recording layer−an average thickness of the thermosensitive recording layer)/the average thickness of the thermosensitive recording layer]×100 where the maximum thickness of the thermosensitive recording layer is a maximum value of the thickness of the thermosensitive recording layer, and the minimum thickness of the thermosensitive recording layer is a minimum value of the thickness of the thermosensitive recording layer, when the thickness of the thermosensitive recording layer is measured at arbitrary 20 points on the thermosensitive recording medium, and the average thickness of the thermosensitive recording layer is an average value of values measured at 18 points excluding the maximum thickness of the thermosensitive recording layer and the minimum thickness of the thermosensitive recording layer among the 20 points, the larger value between an absolute value of (the maximum thickness of the thermosensitive recording layer—the average thickness of the thermosensitive recording layer) and an absolute value of (the minimum thickness of the thermosensitive recording layer—the average thickness of the thermosensitive recording layer) is selected, and the edge of the thermosensitive recording layer is a region of the thermosensitive recording layer that is 3 mm inside from a printing edge of the thermosensitive recording layer.

<8> A thermosensitive recording medium including:
a support; and
a thermosensitive recording layer disposed on or above the support, a support; and
a thermosensitive recording layer disposed on or above the support,
wherein the thermosensitive recording layer includes an electron-accepting compound,
where a solubility of the electron-accepting compound to 100% ethanol at 20° C. is 5.0% by mass or less.

<9> The thermosensitive recording medium according to <7> or <8>, wherein the thermosensitive recording layer is disposed on a partial region of the support.

<10> The thermosensitive recording medium according to any one of <7> to <9>, wherein the support is a transparent film.

<11> The thermosensitive recording medium according to any one of <7> to <10>, further including
a protective layer disposed on or above the thermosensitive recording layer.

<12> The thermosensitive recording medium according to any one of <7> to <11>, further including
a printed layer disposed at at least one of locations selected from on or above the thermosensitive recording layer, between the support and the thermosensitive recording layer, and on or above a surface of the support at a side of which the thermosensitive recording layer is not disposed.

<13> The thermosensitive recording medium according to any one of <7> to <12>, further including
a release layer disposed at an outermost surface of the support at the same side as a side where the thermosensitive recording layer is disposed, and
an adhesive layer disposed at an outermost back surface of the support opposite to the side where the thermosensitive recording layer is disposed.

<14> An image recording method including applying laser light to the thermosensitive recording medium according to any one of <7> to <13> to record an image.

<15> An image recording method including heating the thermosensitive recording medium according to any one of <7> to <13> with a thermal head to record an image.

The thermosensitive recording layer forming liquid according to any one of <1> to <4>, the method for producing a thermosensitive recording medium according to <5> or <6>, the thermosensitive recording medium according to any one of <7> to <13>, and the image recording method according to <14> or <15> can solve the above-described problems existing in the art, and can achieve the object of the present disclosure.

### REFERENCE SIGNS LIST

1: support
2: thermosensitive recording layer
3: protective layer
4: printed layer
7: adhesive layer
8: release layer

1. A thermosensitive recording layer forming liquid, comprising:
an electron-donating compound;
an electron-accepting compound, where a solubility of the electron-accepting compound to 100% ethanol at 20° C. is 50% by mass or less; and
a solvent.

2. The thermosensitive recording layer forming liquid according to claim 1, wherein the electron-accepting compound is at least one selected from the group consisting of compounds, each of which includes a linking group that is a (thio)urea group (—NH—CX—NH—, where X is O or S) or a sulfonyl(thio)urea group (—SO₂—NH—CX—NH— where X is O or S), and a linking group that is an urethane group (—NHCOO—), an amide group (—NHCO—), a sulfonyl group (—SO₂—), or a sulfonylamide group (—SO₂—NH—), and has a structure in which aromatic groups are bonded via the linking groups.

3. The thermosensitive recording layer forming liquid according to claim 1, wherein the electron-accepting compound is at least one selected from the group consisting of compounds, each of which includes a linking group that is an urea group (—NH—CO—NH—), or a sulfonylurea group (—SO₂—NH—CO—NH—), and a linking group that is an amide group (—NHCO—), a sulfonyl group (—SO₂—), or a sulfonylamide group (—SO₂—NH—), and has a structure in which aromatic groups are bonded via the linking groups.

4. The thermosensitive recording layer forming liquid according to claim 1, further comprising:
a photothermal conversion material.

5. A method for producing a thermosensitive recording medium, the method comprising:
applying the thermosensitive recording layer forming liquid according to claim 1 onto a support to form a thermosensitive recording layer.

6. The method according to claim 5, wherein the applying is applying the thermosensitive recording layer forming liquid onto a partial region of the support.

7. A thermosensitive recording medium, comprising:
a support; and
a thermosensitive recording layer disposed on the support, the thermosensitive recording layer including
an electron-donating compound, and
an electron-accepting compound, where a solubility of the electron-accepting compound to 100% ethanol at 20° C. is 5.0% by mass or less,
wherein a variation in a thickness of the thermosensitive recording layer represented by a formula below is 50% or less, where the variation is a variation in a region of the thermosensitive recording layer excluding an edge of the thermosensitive recording layer, Variation in thickness of thermosensitive recording layer (%)=[(the maximum thickness of the thermosensitive recording layer or the minimum thickness of the thermosensitive recording layer−an average thickness of the thermosensitive recording layer)/the average thickness of the thermosensitive recording layer]×100
where the maximum thickness of the thermosensitive recording layer is a maximum value of the thickness of the thermosensitive recording layer, and the minimum thickness of the thermosensitive recording layer is a minimum value of the thickness of the thermosensitive recording layer, when the thickness of the thermosensitive recording layer is measured at arbitrary 20 points on the thermosensitive recording medium, and the average thickness of the thermosensitive recording layer is an average value of values measured at 18 points excluding the maximum thickness of the thermosensitive recording layer and the minimum thickness of the thermosensitive recording layer among the 20 points, the larger value between an absolute value of (the maximum thickness of the thermosensitive recording layer—the average thickness of the thermosensitive recording layer) and an absolute value of (the minimum thickness of the thermosensitive recording layer—the average thickness of the thermosensitive recording layer) is selected, and the edge of the thermosensitive recording layer is a region of the thermosensitive recording layer that is 3 mm inside from a printing edge of the thermosensitive recording layer.

8. A thermosensitive recording medium, comprising:
a support; and
a thermosensitive recording layer disposed on or above the support,
wherein the thermosensitive recording layer includes an electron-accepting compound, where a solubility of the electron-accepting compound to 100% ethanol at 20° C. is 5.0% by mass or less.

9. The thermosensitive recording medium according to claim 7, wherein the thermosensitive recording layer is disposed on a partial region of the support.

10. The thermosensitive recording medium according to claim 7, wherein the support is a transparent film.

11. The thermosensitive recording medium according to claim 7, further comprising:
a protective layer disposed on or above the thermosensitive recording layer.

12. The thermosensitive recording medium according to claim 7, further comprising,
a printed layer disposed at at least one of locations selected from on or above the thermosensitive recording layer, between the support and the thermosensitive recording layer, and on or above a surface of the support at a side of which the thermosensitive recording layer is not disposed.

13. The thermosensitive recording medium according to claim 7, further comprising:
a release layer disposed at an outermost surface of the support at the same side as a side where the thermosensitive recording layer is disposed, and
an adhesive layer disposed at an outermost back surface of the support opposite to the side where the thermosensitive recording layer is disposed.

14. An image recording method, comprising:
applying laser light to the thermosensitive recording medium according to claim 7 to record an image.

15. An image recording method, comprising:
heating the thermosensitive recording medium according to claim 7 with a thermal head to record an image.

16. The thermosensitive recording medium according to claim 8, wherein the thermosensitive recording layer is disposed on a partial region of the support.

17. The thermosensitive recording medium according to claim 8, wherein the support is a transparent film.

18. The thermosensitive recording medium according to claim 8, further comprising:
a protective layer disposed on or above the thermosensitive recording layer.

19. The thermosensitive recording medium according to claim 8, further comprising:
a printed layer disposed at at least one of locations selected from on or above the thermosensitive recording laver, between the support and the thermosensitive recording layer, and on or above a surface of the support at a side of which the thermosensitive recording layer is not disposed.

20. The thermosensitive recording medium according to claim 8, further comprising:
a release layer disposed at an outermost surface of the support at the same side as a side where the thermosensitive recording layer is disposed, and
an adhesive layer disposed at art outermost back surface of the support opposite to the side where the thermosensitive recording layer is disposed.
